(19) United States
(12) Patent Application Publication
(10) Pub. No.: US 2012/0118327 A1
(43) Pub. Date: May 17, 2012

(54) Dust Removal System for Electronic Devices

(76) Inventor: Rouben Mazmanyan, Moscow (RU)

(21) Appl. No.: 13/296,118

(22) Filed: Nov. 14, 2011

Related U.S. Application Data
(60) Provisional application No. 61/414,087, filed on Nov. 16, 2010.

(51) Int. Cl. B08B 5/04; A47L 9/00

(52) U.S. Cl. 134/21; 15/300.1

(57) ABSTRACT

Several techniques are disclosed to prevent dust and other particles from building up inside housings of electronic devices. These allow timely, easy and safe dust removal from the entire volume of the housing of the device without its disassembly by creating directed airflows inside of the housing. Moreover, dust is carried from the enclosure to a dust trap without allowing escape of dust from the enclosure into the ambient air. Dust removal is carried out by creating one or more directed airflows by air injection, exhausting or both air injection and air exhausting to move the dust from the enclosure to the dust trap. In some cases a sealing member is supplied to close off apertures in the enclosure that are not used in the dust collection process.

### CROSS REFERENCE TO RELATED APPLICATIONS

This application claims the priority of the inventor's U.S. Provisional Application No. 61/414,087, filed on Nov. 16, 2010.

### FIELD OF THE INVENTION

The invention relates to the methods of preventing buildup of dust and other particles inside of housings of electronic devices, especially in personal computers and household electronics.

### BACKGROUND OF THE INVENTION

Many people are concerned today about the problem of reduction of content as suspended in the air as well as precipitated dust and other particles inside offices, production premises and especially inside of living accommodations. Dust and other particles settled on the floor surface, walls, furniture, household appliances and electronics could be easily removed whereas the dust getting into the devices such as TV sets, monitors, computers, audio and video equipment builds up there and cannot be removed without disassembly of the housings of the devices. Dust may build up for years and concentrate inside of the devices, which makes its further removal complicated and hazardous for health process.

Aggregated inside of devices dust contains various fibers and particles: spores of microscopic mold and yeast fungi, allergens of cockroaches and dust mites (particles of chitinous shells and products of vital activities). Pets, for example, cats, love to be on housings of electronic devices generating heat. That is why the dust inside of devices may also contain substantial quantities of epidermis, hair and feathers of pets and birds. Dust clusters are the habitat of dust mites which may adversely affect human health as indicated in the publications located on the web-sites of special scientific organizations, agencies and commissions including U.S. Environmental Protection Agency (EPA) and U.S. Consumer Product Safety Commission. For example, as stated in the material posted on the web-site of EPA (http://www.epa.gov), “Body parts and feces from dust mites can trigger asthma in individuals with allergic reactions to dust mites, and exposure to dust mites can cause asthma in children who have not previously exhibited asthma symptoms.” (House Dust Mites by Barbara Ogg, Ph.D., Extension Educator, University of Nebraska, Lincoln, Educational Resource Guide #13, Mar. 27, 2001).

Dust accumulated inside of devices may also contain toxic substances. There are many devices that still are used at homes which enclosures are made of highly flame resistant plastics. The enclosures of such devices (mainly TV sets) contain hazardous brominated flame retardants (BFRs), such as polybrominated diphenyl ethers (PBDEs), tetrabromobisphenol A (TBBPA), hexabromocyclododecanes (HBCDs) and polybrominated dibenzo-p-dioxins/dibenzofurans (PBDD/DFs). Hazardous features of BFRs are described in the publications located on the web-sites of special scientific organizations, agencies and commissions including U.S. Environmental Protection Agency (EPA), European Environment Agency (EEA) and others. As it is described in the article ‘Transfer of brominated flame retardants from components into dust inside television cabinets’ by Takigami H, Suzuki G, Hirai Y, Sakai S. (Chemosphere. 2008; 73:161-169), “These compounds (BFRs) might be released indoors via dust, which presents a potential exposure pathway for humans in the home environment. . . . Analytical results of the TV components showed that the concentrations of PBDEs, TBBPA and PBDFs (48,000 μg/g, 19,000 μg/g and 9600 ng/g as mean values, respectively) were all highest in the rear cabinets. The ΣPBDD concentrations (460 ng/g as a mean value) detected were highest in the circuit board samples. The respective ΣPBDE and ΣPBDF concentrations in the dust samples were 67-500 μg/g (mean 300 μg/g) and 180-650 ng/g (mean 410 ng/g). Such concentrations were 2-3 orders of magnitude higher than those previously reported for house dust samples, which suggests that the brominated compounds are transferred from TV components into dust. Comparison of congener patterns of the brominated compounds in the dust identified the components as the source of these BFRs.”

Hazardous exposure of brominated flame retardants (BFRs) is known and is described in details in various publications of specialized institutions and organizations, such as European Environment Agency—EEA, U.S. Environmental Protection Agency—EPA and others, and in various scientific articles, such as “Concentration of Polybrominated Diphenyl Ethers (PBDEs) in House Hold Dust from Various Countries—Inhalation a Potential Route of Human Exposure.” by Sjodin, A., Paepke, O., McGahee III, E., Jones, R., Focant, J. F., Pless-Mulloli, T., Toms, L. L., Wang, R., Zhang, Y., Needham, L., Herrmann, T. and Patterson Jr., D. (Organohalogen Compounds. Dioxin 2004; 66:3770-3775; “Polybrominated Diphenyl Ethers in House Dust and Clothes Dryer Lint.” by Stapleton, H. et al. (Environmental Science and Technology. 2005; 39(4):925-31; “Is house dust the missing exposure pathway for PBDEs? An analysis of the urban fate and human exposure to PBDEs.” by Jones-Otazo, H et al. (Environmental Science and Technology. 2005; 39(14):5121-5130; “Critical factors in assessing exposure to PBDEs via house dust.” by Allen J G, McClean M D, Stapleton H M, Webster T F. (Environmental Science and Technology Nov. 2008; 34(8):1085).

Timely dust removal from the inside space of devices will prevent the ingress of the accumulated dust containing allergens and harmful toxins into the air and will improve indoor environment. Dust not only can affect human health but can also affect the functioning of devices. It is known that dust can conduct electricity and is a good thermal insulator. Thus, the presence of dust in the housing of a mechanical, electrical, electromechanical or electronic device is unsafe and can lead to a short circuit, overheating of the components of the device and consequently to the failure of the device, and even to its fire.

The prior art offers several different methods to prevent dust accumulation inside of devices such as monitors, computers and consumer electronics.

One of the known methods is the method where vent holes of the housing of a device are per se short vent ducts having zigzag shape. In this case free-flow air stream entering into or flowing out of the device through the vents turns one or more times at a certain angle (usually 90 degrees) passing through the housing of the device. Thus, when the device does not work, the suspended in the air dust precipitates on the surface of the device housing and does not get inside through the vent holes and could be easily removed from the surface of the device housing. Disadvantage of such vent holes as compared to the holes providing a direct airflow is lower rate of air exchange when the heated air inside of the housing outflows from the housing without use of forced ventilation. Therefore, in most consumer electronics that components are substantially heated (for example, plasma TVs), in which it is difficult (for example, because of the paucity of housing volume) or undesirable (for example, in view of the requirements of noise level) the use of forced ventilation (for example, using fans), are used large size vent holes which allow easy penetration of dust.

Another method uses a mechanical filter as a dust trap that is set up in the passageway of airflow entering the device and/or flowing out from the device, which holds dust suspended in the air. The disadvantage of this method is that the filter still lets some part of the dust to penetrate into the housing of the device because of relatively large size of filter cells (pores). Installing an additional electrostatic duster behind of the mechanical filter can eliminate this disadvantage. However, electrostatic duster requires additional high voltage power supply and space to accommodate. These features as well as the relatively high cost make unreasonable or impossible the use of electrostatic duster in low-cost and/or portable and compact devices. This method is not applicable when the use of forced ventilation is difficult or undesirable.

Said above disadvantages could have been addressed by making housing of devices quick detachable without the use of additional tools. In this case the dust inside the housing could be removed with the use, for example, of air gun and/or vacuum cleaner. However, this method also has a range of essential disadvantages. When opening the housing and then when using a brush to sweep the dust, an air gun or vacuum cleaner, some precipitated inside of the device dust imminently turns into suspended state and it may get into respiratory tracts or precipitate on other objects in the room. Another disadvantage is that in some cases when the device is stationary (for example, plasma TV set or monitor placed next to the wall) the access to its rear part and disassembly of the device are difficult and/or takes a lot of time. Moreover, when the hosing or part of the enclosure has been removed, it is easy to damage internal elements of the device (for example, located on the circuit board) by nozzle of the air gun or vacuum cleaner.

### SUMMARY OF THE INVENTION

The present invention provides several techniques that are free of said disadvantages to prevent dust and other particles to build up inside of housings of devices. Said techniques allow timely, easily and safely dust removal from the entire volume of the housing of the device without its disassembly by creating inside of the housing directed airflows entering the hosing through certain apertures in the housing and flowing out of the housing also through certain apertures in the housing without spreading the dust and other particles outside of the housing to the ambient space. One or more said directed airflows are created by one or more air injection and/or air exhaust devices. The distinctive feature of the air injection and/or air exhaust devices used in the present invention is their high performance that is needed for dust removal from housings of electronic devices, which cannot be achieved by fans installed in housings of electronic devices for cooling inner electronic components. Such cooling fans do not have enough capacity not only for raising and transforming into suspension state the dust precipitated on the inner surfaces of a housing and on electronic components inside of the housing for its further easy removal but even for transiting the dust within housings of electronic devices, which evidences the dust accumulating, for example, in computer housings having several inlet and exhaust cooling fans.

The present invention may be used for dust prevention in devices such as electric power supply adapters having vent holes sited on the floor or outlet extension cords without protective shutters on power sockets; floor standing speakers without dust protection covers; keyboards for PC that are typically prone to build up dust and clogging (including small objects: paper clips, pins, etc.), desktop and laptop computers; office equipment such as printers, fax machines, in particular, scanners that do not have dust protection covers; hi-end vacuum tube audio systems, which performance worsens in dusty conditions; kitchen appliances, the presence of dust and other foreign objects inside of which is unacceptable, and so on.

### BRIEF DESCRIPTION OF THE DRAWINGS

FIGS. 1A-1C illustrate an enclosure of an electronic device and elements inside of the enclosure that usually are parts of an electronic device, and also elements that are required to apply the dust prevention techniques provided by the present invention.

FIGS. 2A and 2B illustrate an example of a possible realization of the air closing means actuating.

FIG. 3 illustrates an example of a possible design of the air switcher.

FIG. 4 illustrates an example of possible designs of the air nozzle.

FIGS. 5A-5B illustrate an example of possible design of the manifold.

FIG. 5C illustrates an example of a possible design of the housing of the integrated manifold.

FIG. 6 illustrates an example of a possible design of the moving mechanism.

FIGS. 7A-7B and FIG. 8 illustrate various options of relative positions of an electronic device that is cleaned and external, relative to said electronic device, elements required to apply the dust prevention techniques provided by the present invention.

FIGS. 7A-7B illustrate an example of a possible design of a case of a laptop computer and of a docking station for the laptop computer.

FIG. 8 illustrates an example of a possible design of a soft receptacle for a laptop computer; the docking station and the receptacle include the elements required to apply the dust prevention techniques provided by the present invention.

FIG. 9 illustrates an example of a set of elements included into the automation controlling module and interrelations among those elements.

FIGS. 10A-10B illustrate an example of an algorithm of the automation controlling module operation.

FIG. 11 illustrates an example of application of the dust prevention techniques provided by the present invention for dust removal from a computer keyboard. FIG. 12 illustrates an example of application of the dust prevention techniques provided by the present invention for dust removal from a cabinet of an audio speaker.

### DETAILED DESCRIPTION OF THE INVENTION

In the following description, details of various embodiments in accordance with the invention are set forth and accompanying drawings are given. However, it will be apparent to those of ordinary skill in the art that alternative embodiments of the invention may be implemented using only some of the features of these embodiments, and using alternative combinations of the features of these embodiments, and it also will be apparent that these drawings are given for illustrative purposes only and are not meant to be limiting. These embodiments are described in sufficient detail to enable those skilled in the art to practice the invention. Other embodiments may be utilized and structural, logical, mechanical and electrical changes may be made without departing from the scope of the present invention.

In the following description, various operations are described herein in a particular order and as discrete tasks. However, it is to be understood that the order of description should not be construed to imply that the tasks involved in those operations must be performed in the order in which they are presented or that those tasks must be performed discretely. It should also be recognized that some operations described with respect to one embodiment may be advantageously incorporated into another embodiment. Further, in some instances, well known features are omitted or generalized in order not to obscure the description. In this description, the use of phrases such as “an embodiment”, “embodiments”, “alternative embodiment” and so forth do not necessarily refer to the same embodiment or all embodiments, although they may.

### Definitions

An air passage means is defined as a means adapted for air passage (flow, transportation) through it comprising a body having a plurality of apertures formed in the body, so air can pass through at least one aperture of the plurality of apertures to the inside of the body and pass out from the inside of the body through at least one aperture of the plurality of apertures, the plurality comprising one or more apertures.

An air passageway is defined as a path that air flows between endpoints (at least one initial and one terminal) of the path, wherein each segment of the path is composed by the inside of an air passage means, and wherein the two contiguous segments of the path are composed of the communicating insides of the two connected air passage means if the air path comprises more than one segment.

As used herein, the term ‘and/or’, when used in a list of two or more items, means that any one of the listed items can be employed by itself, or any combination of two or more of the listed items can be employed. For example, if a composition is described as containing items A, B, and/or C, the composition can contain A alone; B alone; C alone; A and B in combination; A and C in combination; B and C in combination; or A, B, and C in combination. Items may be not only objects (things), interrelations between items, but also states, operations over objects, etc. To illustrate, if at some dust cleaning operations the means A, B and/or C are being used, it means that the means A may be used alone; C alone; A and B in combination; A and C in combination; B and C in combination; or A, B, and C in combination.

Embodiments of the present invention provide a Dust Prevention System that utilizes several techniques which allow to timely, easily and safely remove dust and other particles form the entire volume of the housing of an electronic device without its disassembly by means of creating inside of the housing directed airflows entering and flowing out of the hosing through certain apertures in the housing without spreading the dust and other particles outside of the housing. One or more said directed airflows are created by one or more air injection and/or air exhaust devices. However, it will be apparent to those of ordinary skill in the art that the same techniques are applicable for dust and other particles removal from electrical, mechanical and electromechanical devices as well. In the further description of the present invention, for maximum generality and completeness of description, we assume that dust and other particles are removed from the electronic device. Hereinafter the terms “housing”, “enclosure”, “case”, “box”, “cabinet” are equivalents. Also, hereinafter the term “dust” means besides the dust itself as well other particles and small foreign objects that may fall into the device.

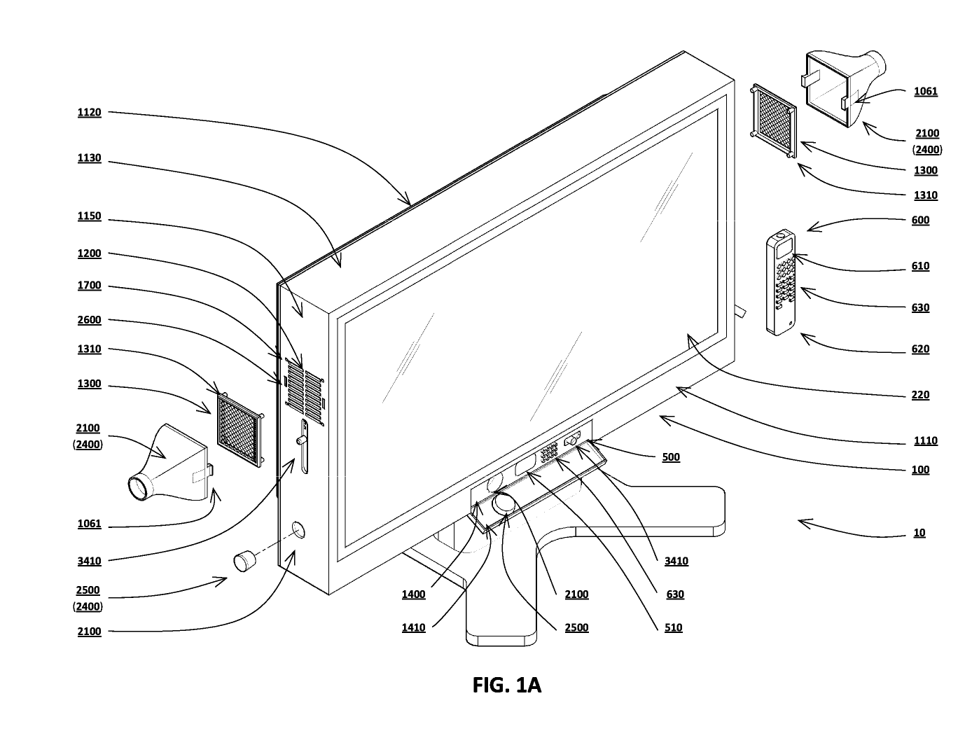

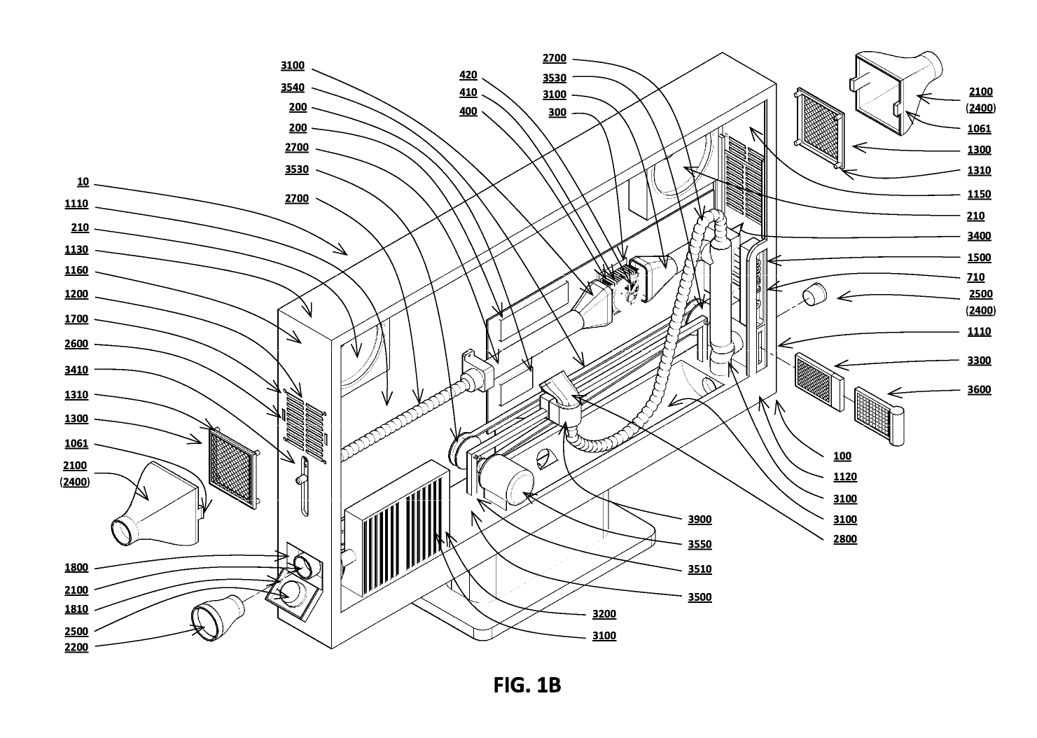

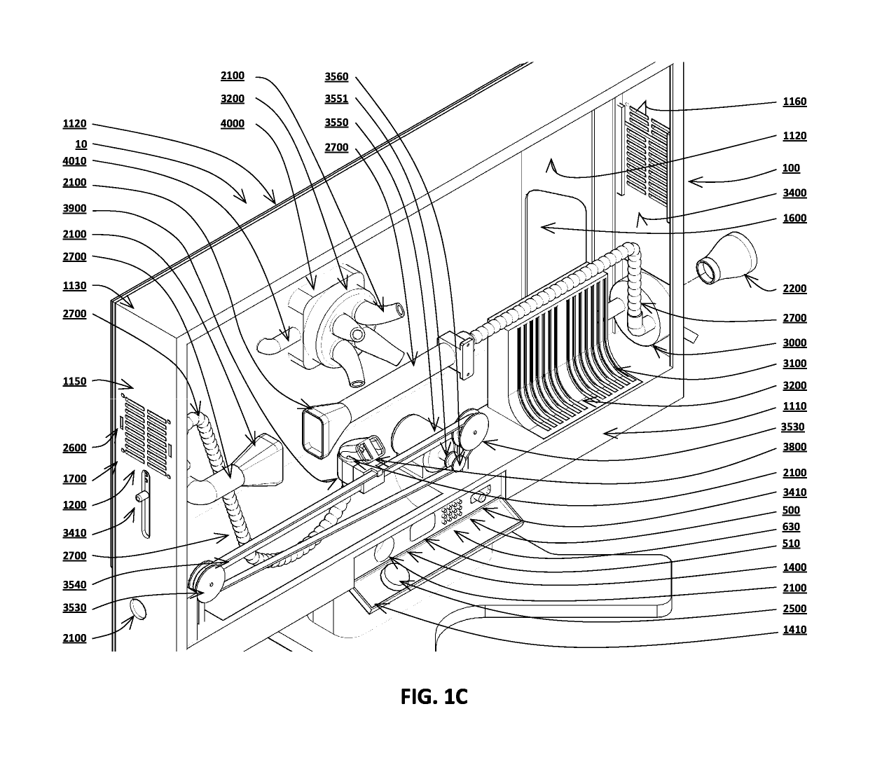

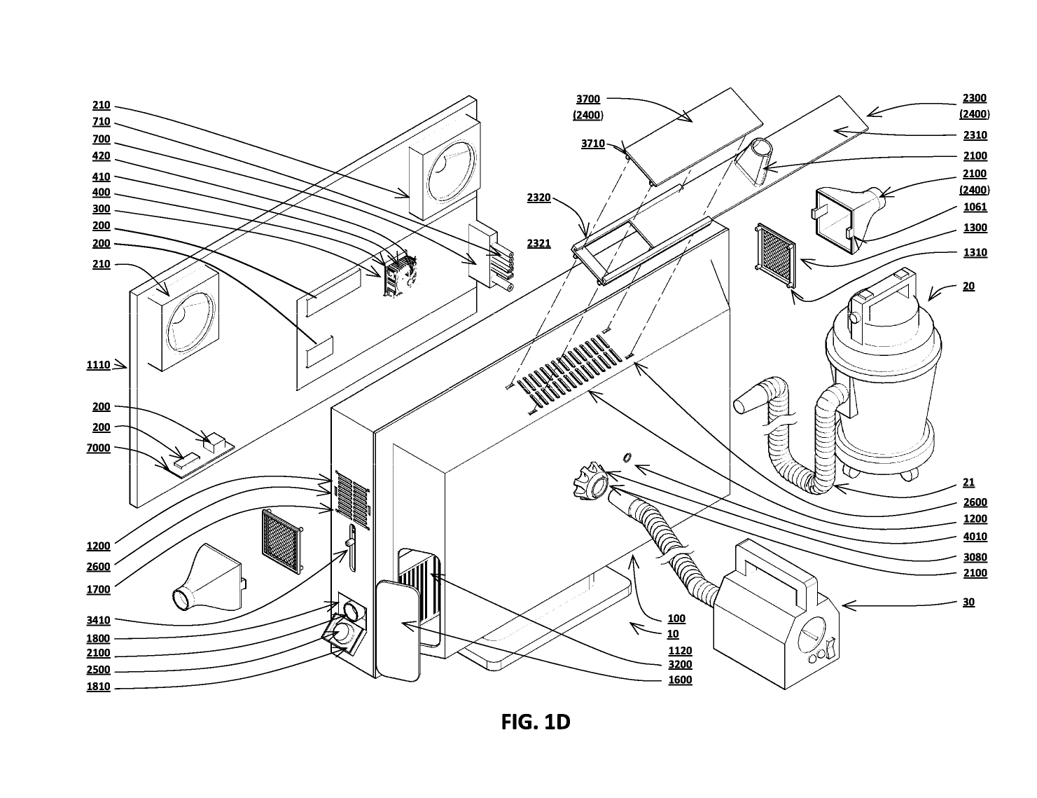

As it is shown in the FIGS. 1A-1B, an electronic device 10 generally includes an enclosure 100; electronic components 200 that do not generate heat or generate small amount of heat and do not require additional cooling; electronic components 300 generating substantial amount of heat which is rejected by heat-dissipating modules 400; control panel 500 of the device 10; external remote control unit 600; communication module 700 with the devices that are not located inside of the enclosure 100. The structure of the electronic components 200 may include devices 210 that generate sound, for example, loudspeakers, and display device 220, such as an LCD display. The structure of heat-dissipating modules 400 may include heat sinks 410 and/or fans 420. The structure of the control panel 500 and external remote control unit 600 may include display 510/610, mini-speaker 520/620, and keyboard 530/630. Communication module 700 may include, for example, infrared adapter for communicating with the external remote control unit 600 and Wi-Fi or IEEE1394 adapters for communicating with computers and multimedia devices, Bluetooth adapter for communicating with mobile devices such as cellular phone or communicator. Communication module 700 may include communication ports 710, for example, IEEE1394 connector.

The enclosure 100 generally includes a front side 1110; a back side 1120; a top side 1130; a bottom side 1140; left 1150 and right 1160 sides; at least one aperture 1200 formed in one or more said sides and serving for heat dissipating from internal elements of the device 10, such as electronic components 200 and 300 and heat-dissipating modules 400, for output outside of the enclosure 100 sound generated by an electronic element located inside of the enclosure 100, or for the like purposes; decorative grids and meshes 1300 covering apertures 1200, compartments 1400 for installing control panel 500, compartments 1500 for outlets 710 of communication module 700, detachable (including quick-detachable without use of additional tools), removable or opening (including pivoting) panels 1600 serving for access to the internal space of the device 10 without disassembling of the enclosure 100. Decorative grids and meshes 1300 may have detachable or removable design which enables easy dismounting and mounting back without use of special tools. In this case decorative grids and meshes 1300 have attaching hardware 1310 (for example, latches) and the enclosure 100 has mating part (for example, grooves for latches) 1700 that allow attaching decorative grids and meshes 1300 to the enclosure 100. Compartments 1400 may include covers (caps) 1410 covering control panel 500.

In the description of the present invention, the term “aperture” relates besides the apertures serving for heat dissipating from internal elements of the device 10, such as electronic components 200 and 300 and heat-dissipating modules 400, for output outside of the enclosure 100 sound generated by an electronic element located inside of the enclosure 100, or for the like purposes, as well to any aperture formed in the enclosure 100 through which air can pass into or out of the inside of the enclosure 100.

For various embodiments of the present invention, to apply one of the mentioned above techniques, the electronic device 10 and/or the enclosure 100 may contain one or more additional elements besides the elements 100-700 and 1110-1700 mentioned above.

The simplest of the said above techniques required for functioning of the Dust Prevention System is applied in an embodiment of the present invention. As it is shown in the FIGS. 1A-1D, according to this embodiment, the electronic device 10 additionally includes one or more air connectors 2100 for connecting an air exhaust or vacuum source device 20, for example, a vacuum cleaner, for air suction from the inner space of the enclosure 100. Such technique is particularly applicable when the free space inside of the enclosure 100 is small. For example, the enclosure of an LCD display has small and vertically elongated volume and a small area of the bottom side 1140. Dust inside of the display builds up at the bottom of the enclosure 10 and on the inner surface of the bottom side 1140, so it would be sufficient to have one air connector 2100 located at the bottom of one of the sides 1120, 1140, 1150 or 1160. If the display is long enough, for example, a big wide-screen 16:9 LCD display, to improve dust removal quality, it is possible to place several air connectors 2100, for example, two air connectors 2100 located at the bottom part on left 1150 and right 1160 sides, respectively, one opposite to another.

For an alternate embodiment of the present invention, to any or to several air connectors 2100 instead of the air exhaust device 20 may be connected an air injection device 30. Thus, air may be forced into and sucked out of (from) the enclosure 100 simultaneously or alternately by suitable air moving apparatus. Alternate operation of the vacuum generating apparatus 20 and the air injection 30 devices enables pulsating mode of dust removal. To illustrate, at the beginning of a dust removal stage may operate only the air injection device 30, creating positive pressure inside of the enclosure 100 and/or raising and transforming the dust into suspension state, and at the end of the dust removal stage may operate only the air exhaust device 20 or both the air exhaust 20 and the air injection 30 devices. Each of the dust removal stages may comprise any sequence of the air exhaust 20 and/or the air injection 30 devices operation. The dust removal stages may cyclically supersede each other interchanging with idling intervals of the air exhaust 20 and the air injection 30 devices. As the air injection device 30 may be used, for example, a home vacuum cleaner with injection function, a compressor, an air bottle, and other means having sufficient air flow capacity. Simultaneous operation of the air exhaust 20 and the air injection 30 devices may be realized for higher performance of the Dust Prevention System and also for creating a directed airflow inside of the enclosure 100. Inflated into the enclosure 100 air enables raising and transforming into suspension state the dust precipitated on the inner surfaces of the enclosure 100 and on electronic components inside of the enclosure 100 for its further easy removal by the air exhaust device 20. There are three options implemented in various embodiments of the present invention to prevent dust blowing out from the inside of the enclosure through open apertures 1200 and through air connectors 2100 not connected with the devices 20 and 30 when the air injection device 30 operates alone or along with operation of the air exhaust device 20.

The first option intends the use of the air exhaust device 20 having power considerably exceeding the power of the simultaneously operating air injection device 30. This option features by its low efficiency when the open apertures 1200 and not connected air connectors 2100 are located in the operating zone of the injection airflow and/or when they have substantial sectional area.

The second option intends such design and location of the apertures 1200 and the air connectors 2100 that when connecting the air injection device 30 to any or to a certain one or more air connectors 2100, open apertures 1200 and not connected air connectors 2100 is for sure beyond the operating zone of the injection airflow. This option is applicable only for the specially designed enclosures in which the air connectors 2100 connected with the air exhaust 20 and the air injection 30 devices are aligned and are close to each other.

The third option intends equipping the open apertures 1200 and not connected air connectors 2100 with dust blowout preventing and/or air closing means. This option is the simplest, economically efficient, and applicable for already produced or most of newly being produced enclosures for electronic devices.

The dust blowout preventing means, such as dust filters 3300, equipping the apertures 1200 or being connected with the apertures 1200, prevent dust blowing out of the inside of the enclosure 100 to the ambient space but allow air to pass through them. The air closing means, such as mechanical or electrical (electromagnetic) valves 2900 and the shutters 3400, equipping or being connected with the apertures 1200, block air passage through them. It is to be understood that the dust blowout preventing and/or the air closing means may be installed at any place of an air passageway on the way from the dust removal point (the air nozzle 3100 included as well for the initial point of the air path) to the air connector 2100 or to the hose fitting 40. Alternatively, the dust blowout preventing and/or the air closing means may be connected with or may equip any of the air passage means composing said air passageway to prevent dust and/or air passing through the means with which the dust blowout preventing and/or the air closing means is connected. The air closing means may be equipped with a mechanical, electrical, electro-mechanical, or electronic drive mechanism 3410 providing the air closing means capacity variation and controlled automatically, or by a person (manually), or upon a command of a person (for example, by pressing certain key at the keyboard 530/630), or upon a command of the controller (processor) 7010, or operated by air passing through the air closing means or through the air passage means with which the air closing means is connected or which is equipped with the air closing means. To illustrate, the air closing means equipping an air connector 2100 may be closed and is opening only when the hose fitting 40 is being attached; or it may open when there is no airflow of certain strength and/or direction through the air connector 2100. In the last case in the capacity of the valve 2900 may be used a swing-check gate preventing the air to pass through the valve 2900 in the direction from the inside of the enclosure 100 to the outside. An example of the manually actuated air closing means is illustrated in the FIGS. 1A-1D. As it is shown in the FIGS. 1A-1D, the two air closing means made in form of the slidable shutters 3400 are installed at the inner surfaces of the left 1150 and right 1160 sides of the enclosure 100 in the guide slots 2320 enabling longitudinal movement of the shutters 3400 up and down, which allows a person to open and close the apertures 1200 formed in the left 1150 and right 1160 sides of the enclosure 100 by actuating the drive mechanisms 3410 (the handles) passing through the slots 3420 formed in the sides of the enclosure 100.

The dust blowout preventing means may also be equipped with a mechanical, electrical, electro-mechanical, or electronic drive mechanism 3410 that is operated and controlled the same way as one equipping the air closing means referred to above. It may be done to ensure better ventilation through an aperture 1200 or through an air connector 2100 equipped with the dust blowout preventing means: in the position ‘open’ the dust blowout preventing means does not block the airflow passing through the aperture 1200 or through the air connector 2100 and respectively doesn't catch the dust; in the position ‘closed’ the dust blowout preventing means blocks the airflow passing through the aperture 1200 or through the air connector 2100 to catch the dust, which obviously worsens the ventilation through the aperture 1200 or through the air connector 2100.

The use of the air closing means not only prevents dust blowing out from the inside of the enclosure 100, but also allows to form inside of the enclosure 100 airflows having various directions in case if only the air exhaust device 20 is connected to an air connector 2100 and the air injection device 30 is not connected to any of the air connectors 2100. In this case, opening sequentially some of the air closing means and simultaneously closing the others, forms airflows inflowing into the enclosure 100 through the certain open apertures 1200 and not connected air connectors 2100 that are sucked out by the air exhaust device 20 through the air connector 2100 to which the air exhaust device is connected.

For various embodiments of the present invention, the air exhaust device 20 and/or the air injection device 30 may be integrated in the device 10 and located inside of the enclosure 100.

For various embodiments of the present invention, an air connector 2100 may be tapered, may have thread, bayonet or other joints for quick and convenient coupling of the hose fitting 40 of the air exhaust 20 or the air injection 30 devices, for example, a vacuum cleaner or an air compressor, with the air connector 2100. The design of an air connector 2100 may be such as to prevent the transmission of mechanical forces to the air connector 2100 via the hose fitting 40. For example, an air connector 2100 may consist of two parts: fixed and mobile. The fixed part is rigidly connected to the enclosure 10, and the mobile part is connected to the fixed part through a hinge (ball joint) enabling rotation of the mobile part in any direction relative to the fixed part. Such mobile design of an air connector 2100 also enables formation of airflows passing through the air connector 2100 in different directions. For easy connection of the air exhaust 20 or air injection 30 devices, an air connector 2100 may also have a telescopic design providing extension of the air connector bends 2100 relative to the enclosure 100. In order not to impair the appearance of the device 100, an air connector 2100 may be placed in special compartments 1800 of the enclosure 100. The compartments 1800 may be equipped with decorative covers (caps) 1810. An air connector 2100 may also be located in the compartments 1400. The air exhaust 20 or air injection 30 devices may be connected to an air connector 2100 via an additional adapter-reducer 2200 reducing cross section of the airflow and thus increasing the flow rate and/or allowing coupling the hose fitting 40 of a larger diameter with the air connector 2100 of a smaller diameter.

For various embodiments of the present invention, an air connector 2100 may let the hose fitting 40 or a nozzle attached to the hose fitting 40 to go through it, so that a first part of the hose fitting 40, having passed through the air connector, positions inside of the enclosure 100 while a second part of the hose fitting connects with the air connector. If the first part of the hose fitting 40 is long enough, it may guide air from or to a certain point of the inside of the enclosure 100 that is sufficiently far from the air connector 2100. In such case, the device 10 may additionally comprise one or more supporting elements attached to the enclosure 100 that are disposed along the first part of the hose fitting 40 inside of the enclosure 100 and that support or lock with the first part when the second part is connected with the air connector 2100. The hose fitting 40 and an attachment for the hose fitting 40 (for example, the air nozzle 3100 attached to the hose fitting 40) may be of an unstraight shape, for example, may be L-shaped, so they guide an airstream created by the air exhaust 20 or air injection 30 devices angularly relative to the axis of the air connector 2100. Alternatively, the inner relative to the enclosure 100 part of an air connector 2100 may be implemented in a form of a free-shaped air nozzle for forming a certain shape of an air stream passing through the air connector.

For various embodiments of the present invention, an air connector 2100 may be designed as to move relative to the enclosure 100 to enable formation of airflows of different directions passing through the air connector 2100. In this case an air connector 2100 may not be connected with the enclosure 100 directly but, for example, through a sliding device 2300, as it is show in the FIG. 1D. The sliding device 2300 consists of the sliding plate 2310 moving along the back side 1120 of the enclosure 100 with the mounted on it the air connector 2100, and also of the guide slots 2320 enabling longitudinal movement of the sliding plate 2310 along the back side 1120, the guide slots 2320 having mounts 2321 for latching to the mating parts 1700 and/or 2600 and/or to the apertures 1200 and/or to decorative grids and meshes 1300 and/or to attaching hardware 1310 (decorative grids and meshes 1300 should be removed beforehand) of the enclosure 100. In this case the sliding device 2300 may be implemented as separate add-on module 2400 and can be easily installed over at least one aperture 1200 instead of decorative grids and meshes 1300 that should be removed beforehand. It will be apparent to those of ordinary skill in the art that any other design alternative to the design of the sliding device 2300, providing connection by turns several apertures 1200 with the air connector 2100, may be used. The device 2300 may be equipped with an electrical, electro-mechanical, or electronic moving mechanism 3500 providing linear, circular or any other kind of the air connector 2100 shifting operated and controlled automatically, or by a person (manually), or upon a command of a person (for example, by pressing certain key at the keyboard 530/630), or upon a command of the controller (processor) 7010, or operated by air passing through the air connector 2100. For example, the device 2300 may have a design providing circular shifting of the air connector 2100 mounted on it instead of linear, etc. Alternatively, the sliding device 2300 connected with the movable air connector 2100 mounted on the sliding plate 2310 may provide switching of the movable air connector among other air connectors directly connected to the enclosure 100 by its moving to align the movable air connector with any other of the directly connected air connectors.

A sealing member preventing dust blowout may be the detachable plug 2500 mounted on the butt end of the air connector 2100, the butt end being internal or external relative to the enclosure 100, or mounted to the enclosure 100 instead of the air connector 2100 if the air connector 2100 has detachable or removable design and if the plug 2500 is designed as an add-on module 2400. In case when the air connector 2100 is located in the compartment 1800 or in the compartment 1400, the role of the dust blowout preventing means may as well implement the cover (cap) 1810 or 1400, each of the covers (caps) being fitted out with the plug 2500 that at closing the cover (cap) 1810 gets into the air connector 2100 and prevents the airflow through the air connector 2100. The filters 3300 may be made of plastic or similar materials and have quick-detachable design enabling a person to easily take the filters 3300 out of the enclosure 100, clean them from dust and install back. The filter 3300 may have depth (3-D) design to allow trapping and collection of a considerable amount of dust.

In preferred embodiments of the invention dust-laden air passes through a dust trap in which the dust remains until the trap is cleaned. The trap may comprise a filter 3300 attached more or less directly to an enclosure or may comprise a filter or cyclonic trap of the sorts that are commonly used as parts of vacuum cleaners 20. The reader will recognize that many dust trapping methods are known and may be used with the present invention. These comprise, but are not limited to as electrostatic precipitators, water-spray air cleaners, oil-bath air filters and the like.

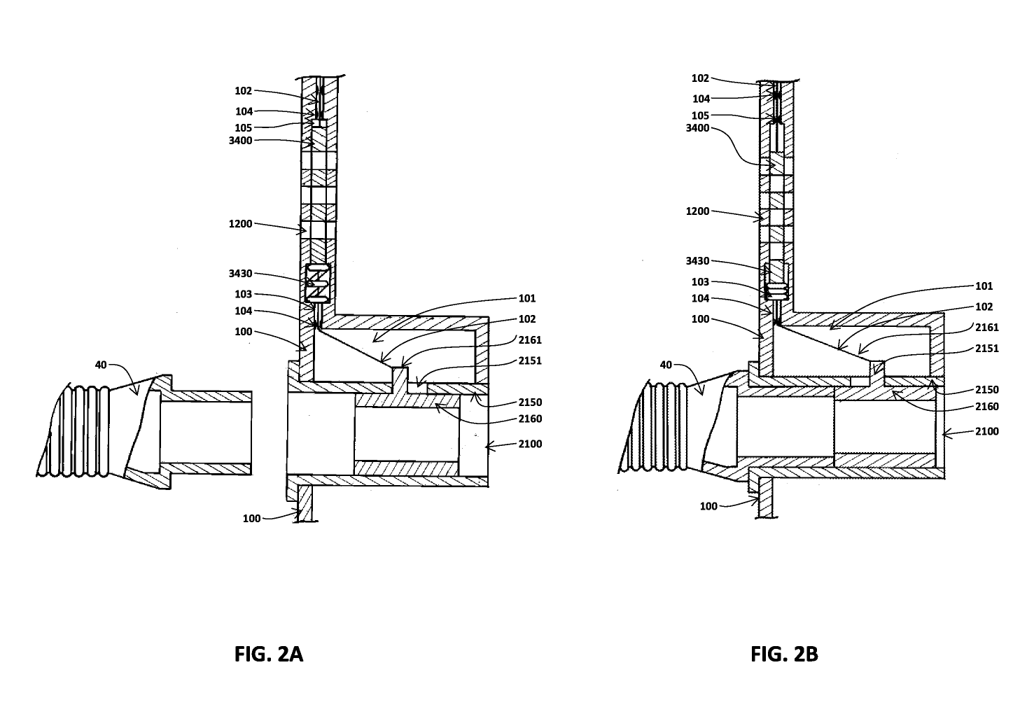

For various embodiments of the present invention, the drive mechanism 3410 of the dust blowout preventing or air closing means equipping one or several air passage means, such as the apertures 1200, may also be connected with an air connector 2100 for its actuating (i.e., for the dust blowout preventing or air closing means opening or closing) by connecting the hose fitting 40 to the air connector 2100. It may be done for convenient cleanup of the interior of the enclosure 100: to make cleanup it is enough to make only one action—to attach the hose fitting 40 to the air connector 2100, which will actuate the drive mechanism 3410 and respectively will open or close the dust blowout preventing and/or air closing means in a given combination. FIGS. 2A and 2B demonstrate an example of a possible realization of the air closing means actuating. In accordance with the FIGS. 2A and 2B, the air connector 2100 comprises fixed 2150 and mobile 2160 parts; both parts have the form of quill cylinders, wherein the outside diameter of the mobile part 2160 is slightly smaller than the inside diameter of the fixed part 2150. The fixed part 2150 is mounted to the enclosure 100. The mobile part 2160, mounted inside of the fixed part 2150, is able to move along the longitudinal axis of the air connector 2100. The external surface of the mobile part 2160 has the boss 2161 extending outside of the fixed part 2150 through the slot 2151 formed in the fixed part 2150. The slot 2151 guides the boss 2161 at the mobile part 2160 sliding. The slot 2151 is located inside of the hollow 101 formed in the enclosure 100. The flexible strap 102, which is disposed in the channel 103 formed in the enclosure 100 and which is guided by the rollers 104, connects the boss 2161 with the slidable shutter 3400 disposed in the hollow 105 formed in the enclosure 100. The hollow 105 is of a slightly larger size than the slidable shutter 3400 for enabling longitudinal movement of the slidable shutter 3400. The slidable shutter 3400 is spring-assisted by the helical spring 3430 for enabling aligning the slotted holes 3440 formed in the slidable shutter 3400 with the apertures 1200 formed in the enclosure 100. While the hose fitting 40 is not connected to the air connector 2100, the slotted holes 3440 and the apertures 1200 are aligned, which allow air passing through the apertures 1200 as it is shown in the FIG. 2A. When connecting the hose fitting 40 to the air connector 2100, the fixed part 2160 is sliding along the longitudinal axis of the air connector 2100, which moves the flexible strap 102 and slides the slidable shutter 3400 until closing the apertures 1200 by the blank parts of the slidable shutter 3400 interchanging with the slotted holes 3440, as it is shown in the FIG. 2B. Instead of the slidable shutter 3400 one may install a different sealing member such as the 3300, which may be operable the same way as the slidable shutter 3400. It is to be understood that more than one slidable shutter 3400 may be shunted or connected in series with one air connector 2100 via more than one flexible straps 102.

For various embodiments of the present invention, an air connector 2100 may be implemented together with the enclosure 100 as an integral part, or as separate items mounted with special tooling, or as separate add-on module 2400 for the enclosure 100, which may be attached to and removed from the enclosure 100 without using tools. To illustrate, an air connector 2100 may be implemented in the form of interchangeable nozzles (for example, the nozzles 3100) for the hose fitting 40 or in the form of an air nozzle integrated with the dispensing pump of air bottles. In case when an air connector 2100 and/or the sliding device 2300 are designed as separate add-on modules 2400, they may be installed over the apertures 1200. In this case the add-on modules 2400 may have attaching hardware 1061 that allow mounting of the add-on modules 2400 to the apertures 1200 and/or to decorative grids and meshes 1300 and/or to attaching hardware 1310 (decorative grids and meshes 1300 should be removed beforehand) and/or to special mounts 1700 and/or 2600 located on the enclosure 100 around the apertures 1200.

In an alternate embodiment of the present invention, several or all air connectors 2100 may be replaced by one air connector 2100, thereat the air connector 2100 is connected with several air passage means, for example, an elongated airtight passageway comprising air ducts 2700, each of which serves for dust removal from a certain place inside of the enclosure 100. This could be done for convenient cleanup of the interior of the enclosure 100: when cleaning up the room where the device 10 is located using, for example, a vacuum cleaner, it is enough to take the usual attachments out of the vacuum cleaner hose fitting (for example, the attachment to clean up furniture) and connect it to only one air connector 2100. In this case several air passage means, for example, air ducts 2700, connected to one air connector 2100 form airflows entering through the air passage means, for example, air ducts 2700, to the air connector 2100 from various parts of the enclosure 100. As it is shown in the FIG. 1B, the air passage means, specifically the air ducts 2700, may be connected to the air connector 2100 via the air hub 2800 integrating airflows coming from several of said air passage means, specifically the air ducts 2700, into one stream and directing them into one air connector 2100. When in the capacity of the air exhaust 20 or the air injection 30 devices is used a household vacuum cleaner or an air compressor connected to an air connector 2100 that is connected with several air passage means, its power may not be sufficient for the simultaneous dust removal from several areas inside of the enclosure 100. Because of this, any of the air passage means forming (composing) an air passageway on the way from the point of dust removal (including air nozzle 3100 as the starting point of the air passageway) to the air connector 2100 may be connected with an air closing means, such as a valve 2900 and/or mechanical or electrical air switcher 3000, allowing closing air passage through the means with which it is connected.

A valve 2900 enables airflow block coming in or from the air connector 2100 through a certain air passage means, thereat the power of suction or inflation through the remaining air passage means connected to the air connector 2100 is increasing. A valve 2900 may be closed (open) by a person or upon a command of a person (for example, by pressing a certain key on the keypad 530/630) or closed upon a command of the controller (processor) 7010. Instead of a valve 2900 its role may perform a valve 2900 or a plug 2500 connected with an air passage means. The air switcher 3000, when it is connected with several air passage means, blocks the airflows passing through the certain of said air passage means and simultaneously opens the others for passing air through them. The air switcher 3000 may be operated (commutated) and controlled by a person (manually) or upon a command of a person (for example, by pressing a certain key on the keypad 530/630), or upon a command of the controller (processor) 7010, or under the pressure of the airflow passing through the air passage means connected with the air switcher 3000.

In still alternate embodiment of the present invention, any of the air passage means forming (composing) an air passageway on the way from the point of dust removal (including air nozzle 3100 as the starting point of the air passageway) to the hose fitting 40 may be equipped by or connected with an air closing means, such as a gate valve 2900 and/or mechanical or electrical air switcher 3000, allowing closing air passage through the means with which it is connected. Thus, it is to be understood that any of the air passage and air closing means may be located externally relative to the enclosure 100. To illustrate, an air switcher 3000 may be connected to the hose fitting 40, and each of several elongated airtight passageways, such as air ducts 2700, may connect the air switcher 3000 with an air connector 2100. Alternatively, each of several air ducts 2700 equipped with a valve 2900 may be connected to the hose fitting 40, for example, through an air hub 2800, and so may connect the hose fitting 40 with several air connectors 2100.

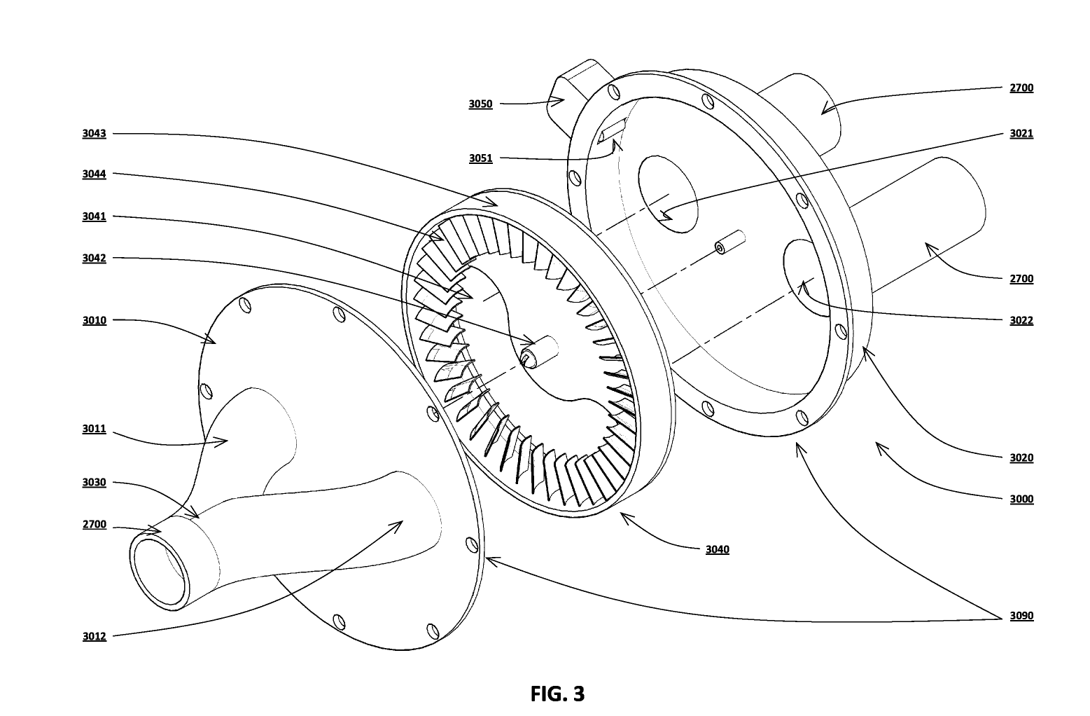

FIG. 3 demonstrates an example of a possible realization of the air switcher 3000. In accordance with the FIG. 3, the air switcher 3000 may include the housing 3090 having the front 3010 and the rear 3020 parts; the left 3011 and the right 3012 front holes through which the air flows into the air switcher 3000; the left 3021 and the right 3022 rear holes through which the air outflows from the air switcher 3000; the front duct 2700 connected though the wye 3030 to the front part 3010 of the air switcher 3000 in the way that the ends of said wye 3030 are located against the left 3011 and the right 3012 front holes; the left and the right rear air ducts 2700 connected to the rear part 3020 of the air switcher 3000 in the way that the ends of said air ducts 2700 are located against the left 3021 and the right 3022 rear holes; the disc 3040 with the hole 3041 mounted inside of the housing 3090 between the front 3010 and the rear 3020 parts with the attaching hardware 3042, the disc having the band-load carrying surface 3043 located at one side of the disc along its perimeter perpendicular to the disc and the vanes 3044 located at the opposite side of the disc along its perimeter; the speed reducer 3050 having the roller 3051 that is hold down to the band-load carrying surface 3043 for reducing the rotation velocity of the disc 3040. The center of the disc 3040 and the attaching hardware 3042 are located in the way that the centers of the left 3021 and the right 3022 rear holes or the left 3011 and the right 3012 front holes are on the radiuses of the disc. The hole 3041 has an arch shape, and the axial line of the hole 3041 is located on the circumference that passes the centers of the holes 3011, 3012, 3021, and 3022. The width of the hole 3041 may be equal or may insignificantly be greater or lesser than the diameter of the holes 3011, 3012, 3021, and 3022. The length of the hole 3041 is such that when the disc 3040 turns at a given angle (for example, 90 degrees) under the pressure of the air passing through the hole 3041, one of the holes 3021 and 3022 remains open for a given time while the other one remains closed. At further rotation of the disc 3040 in the same direction at the same angle (90 degrees), one of the holes 3021 and 3022 that previously was closed opens and another one respectively closes. The time for toggling between the two holes 3021 and 3022 may be varied by changing the rate of the airflow passing through the hole 3041 and/or by controlling the speed reducer 3050. It is to be understood that such design of the air switcher 3000, possibly with different angle of setting of the vanes 3044, ensures its operation also when the air flows into the air switcher 3000 in the opposite direction—through the left 3021 and the right 3022 rear holes and outflows through the left 3011 and the right 3012 front holes. Moreover, the vanes 3044 may have flexible articulation so they can be turned to the operating angle to ensure operation of the air switcher 3000 when the air is inflated into or is sucked out of it. The pitch of the vanes 3044 may be changed automatically depending on the direction and/or the power of the airflow passing through the air switcher 3000. Alternatively, the air switcher 3000 may be equipped with a mechanical, electrical, electro-mechanical, or electronic drive mechanism 3410 providing the air vanes 3044 angle variation and controlled automatically, or by a person (manually), or upon a command of a person (for example, by pressing certain key at the keyboard 530/630), or upon a command of the controller (processor) 7010, or operated by air passing through the air switcher 3000. In case if the toggling of the air switcher 3000 is realized upon the command of the controller (processor) 7010, the disc 3040 may be rotated by a drive mechanism 3410 operated and controlled by the controller (processor) 7010. The disc 3040 may not have the vanes 3044 installed on it and may be revolved by the speed reducer 3050 rotated by an impeller installed in the wye 3030 or in the left or the right rear air ducts 2700. In case if the air switcher 3000 is commutated upon a command of a person (for example, by pressing a certain key on the keypad 530/630) or upon a command of the controller (processor) 7010, the disc 3040 may be rotated by the roller 3051 that in its turn is rotated by a motor which shaft is coupled with the speed reducer 3050. It will be apparent to those of ordinary skill in the art that any other alternative designs of the air switcher 3000 may be used.

In an embodiment of the present invention, an air passage means connected with the air switcher 3000 is one or more air nozzles 3100, as it is shown in the FIG. 1C. These nozzles 3100, located on the surface of the housing 3090, may be turned in different directions for efficient dust removal from the elements located in the various parts of the enclosure 100. In the FIG. 1C is shown the air switcher 3000 located on the back side 1120 providing the airflow redistribution among the air nozzles 3100 by means of the switching mechanism 3070 that is installed inside of the housing 3090. The switching mechanism 3070 may have similar design as the disc 3040. The switching mechanism 3070 may be activated by turning the ring knob 3080 mounted on the external surface of the back side 1120.

For various embodiments of the present invention, an elongated airtight passageway, such as an air duct 2700, may have open profile. Moreover, a part of the air ducts 2700 may have open profile while another part—closed profile, wherein the air duct 2700 by its open part of the profile abuts on any element located inside of the enclosure 100 to complement to closed profile. Such design of an air duct 2700 may be used when, for example, the air duct 2700 runs nearby to a circuit board. In such case the surface of the circuit board may close the open profile of the air duct 2700, which may ensure simpler assembly of the device 10 and more rationally utilize the internal space of the enclosure 100. Optionally, an air duct 2700 may be composed of two open-profile longitudinal halves. Each of the two halves (which per se is the open-profile air duct 2700) is disposed inside of the enclosure 100 so that at enclosure 100 assembling each of the two halves (each of the two open-profile air ducts 2700) mates with the counterpart to form one closed-profile air duct 2700.

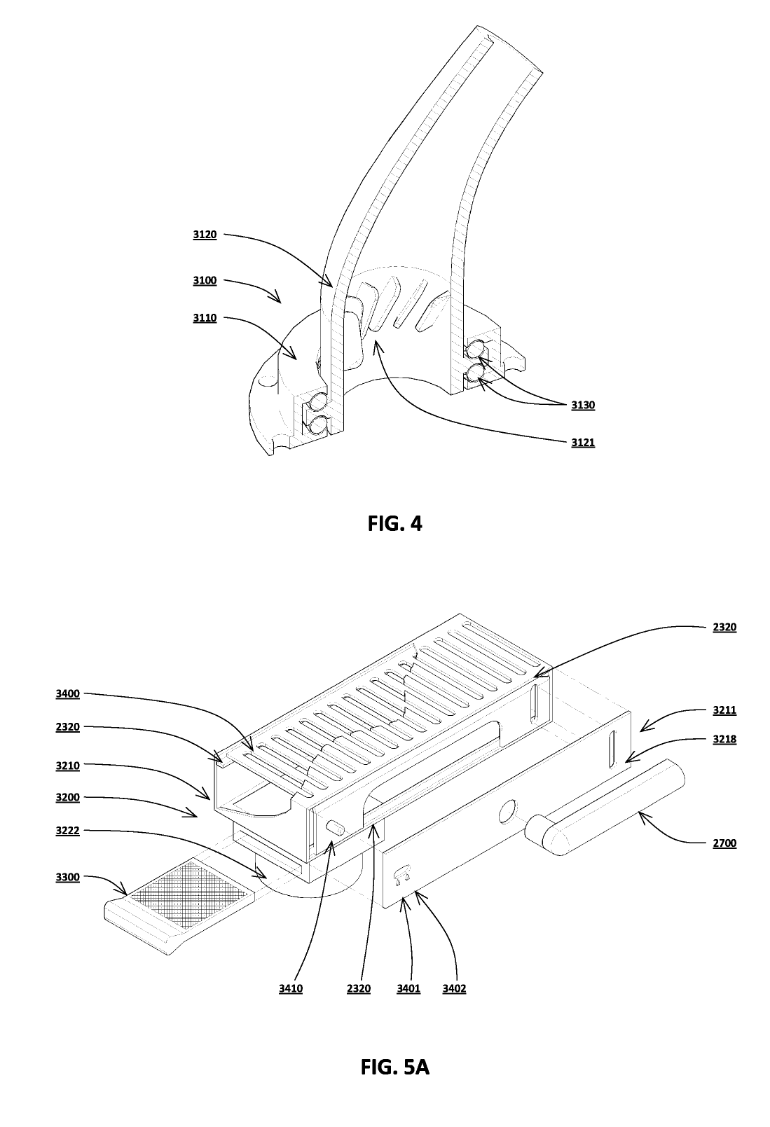

For various embodiments of the present invention, an elongated airtight passageway, such as an air duct 2700, may have an air nozzle 3100 located at the end of the elongated airtight passageway forming an airflow of a certain shape incoming into or outcoming from the elongated airtight passageway. For example, the end of an air duct 2700 may be installed close to the side face of a heat-dissipating module 400 for removing dust solely from this module. In this case the air nozzle 3100 may be of the same size or slightly larger than the side face of the heat-dissipating module 400. In case if it is required to remove the dust from a larger surface, an air nozzle 3100 may have cone shape widening towards its end. An air nozzle 3100 may also be a part of the enclosure 100. As it is shown in the FIGS. 1B-1C, an air nozzle 3100 may be in the form of extended groove (for example, semi-cylinder form) in the bottom side 1140 of the enclosure 100. The groove allows the dust to accumulate in the air nozzle 3100 without spreading throughout the whole enclosure while the air exhaust device 20 is not working (is turned off). In this case the air nozzle 3100 also implements the functions of a dust collector. An air nozzle 3100 may be mobile and able to change its direction under influence of airflow passing through the air nozzle 3100. In the FIG. 4 is shown an example of a possible realization of an air nozzle 3100 rotating under passing through the air nozzle 3100 air stream. This design includes the fixed part 3110, the mobile part 3120, device (bearing) 3130 articulating the mobile and the fixed parts, and the blades 3121 mounted to the mobile part 3120. The airflow passing through the air nozzle 3100 actuates the blades 3121 forcing the mobile part 3120 to rotate relative to the fixed part 3110. Alternatively, an air nozzle 3100 may be equipped with a mechanical, electrical, electro-mechanical, or electronic moving mechanism 3500 providing the air nozzle 3100 rotary movement operated and controlled automatically, or by a person (manually), or upon a command of a person (for example, by pressing certain key at the keyboard 530/630), or upon a command of the controller (processor) 7010. A mechanical moving mechanism 3500, which can be internal or external relative to the air nozzle 3100, may be operated by air actuating the blades 3121 composing the moving mechanism 3500, or may be actuated by a person. An air nozzle 3100 may also include an air closing means, such as the valve 2900 referred to above.

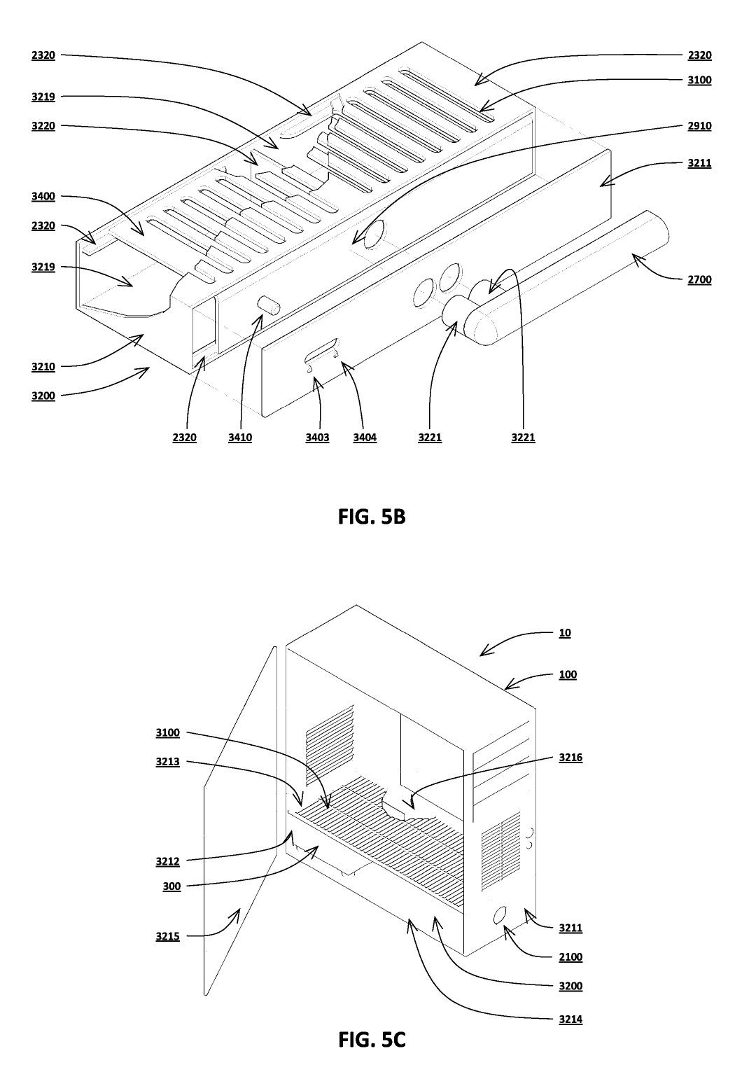

For alternate embodiments of the present invention, an elongated airtight passageway, such as an air duct 2700 may have plurality of air nozzles 3100 located at the end of the elongated airtight passageway. In this case said plurality of the air nozzles 3100 may be integrated in a single manifold 3200. The manifold 3200 may be made as a box 3210 on one or several sides of which are located the plurality of the air nozzles 3100, the box being connected to one or several air ducts 2700. The air nozzles 3100 located on the sides of the box 3210 may be of different sizes and also may be directed into different directions. In the simplest case, the role of the air nozzles 3100 may perform a range of the slotted holes located on the sides of the box 3210, as it is shown in the FIGS. 1B-1C. An example of a possible realization of a manifold 3200 is presented in the FIG. 5A. In the FIG. 5A the box 3210 is demonstrated with the detached front panel 3211 and with disconnected air duct 2700. The design of the manifold 3200 illustrated in the FIG. 5A allows not only to remove dust from the surrounding space inside of the enclosure 100 when the manifold is connected with the air exhaust device 20 but also to effectively remove dust accumulating in the manifold 3200. In this case the manifold 3200 also performs the functions of a dust collector. For this purpose the manifold 3200 besides the box 3210, the air nozzles 3100 implemented in the form of slotted holes located on the top panel 3213 of the box 3210, and the air duct 2700 coupled with the box 3210 also contains an air closing means in a form of the shutter 3400 and ventilator 3222 with the installed in front of it filter 3300, as it is shown in the FIG. 5A. The shutter 3400 slides in the guide slots 2320 enabling longitudinal movement of the shutter 3400 along the top panel 3213 of the box 3210 having the slotted holes 3100. The shutter 3400 is connected with a mechanical, electrical, electro-mechanical, or electronic drive mechanism 3410 providing the shutter 3400 movement actuated and controlled automatically, or by a person (manually), or upon a command of a person (for example, by pressing certain key at the keyboard 530/630), or upon a command of the controller (processor) 7010, or actuated by air passing through the air switcher 3000. The shutter 3400 may also be actuated when the air exhaust device 20 is attached to the air connector 2100, or when there is airflow of a certain strength and/or direction through the manifold 3200. When the shutter 3400 is actuated by a person, the drive mechanism 3410 (the handle) of the shutter 3400 may pass through the slot 3420 and extends from an external side of the enclosure 100 as it is shown in the FIG. 5A. The shutter 3400 may have two positions—‘open’ 3401 and ‘closed’ 3402 and/or a range of intermediate positions. In the position ‘open’ 3401 the shutter 3400 opens all air nozzles 3100 located on the top panel 3213 of the box 3210 for free airflow through them, and in the position ‘closed’ 3402 respectively closes them. In order to remove accumulated dust from the manifold 3200 at the position of the shutter 3400 ‘closed’ and switched on the air exhaust device 20, is required air intake into the manifold 3200. To ensure that air intake the box 3210, the manifold 3200 may have the hole 3218 for air intake located, for example, at the most remote from the entry point of the air duct 2700 into the box 3210 to create directed airflow through the all manifold 3200 from the hole 3218 up to the point of the air outlet from the manifold 3200. In the intermediate positions the shutter 3400 partially closes all air nozzles 3100 or closes (completely or partially) only a part of all air nozzles 3100 located on the top panel 3213 of the box 3210. Intermediate positions of the shutter 3400 may be used to enable air inflow into the manifold 3200 not through all but only through certain air nozzles 3100. It is necessary, for example, to create in the manifold 3200 a directed airflow in case when the box 3210 does not have the hole 3218. It is possible to use the intermediate positions of the shutter 3400 to control throughout performance of the air nozzles 3100 to ensure, for example, airflow velocity change passing through them: partial closing of the air nozzles 3100 increases the velocity of airflow passing through them at constant power of the air exhaust device 20. Intermediate positions of the shutter 3400 also may be used when the box 3210 has quite large volume and the power of the air exhaust device 20 is not sufficient for simultaneous dust removal through the all air nozzles 3100 of the manifold 3200. In this case the box 3210 may be additionally divided onto several compartments 3219. Sliding the shutter 3400 opens air nozzles 3100 through which the air flows into a one of the compartments 3219 and closes air nozzles 3100 of one or more of the remaining compartments 3219. In order to sequentially remove the dust through the air nozzles 3100 located in various parts of the manifold 3200, the volume of each of the compartments 3219 may be separated from the volumes of the other compartments 3219. Herewith, the compartments 3219 are connected to the single air duct 2700 through air couplers 3221, before, after or in which are installed an air closing means, such as the valves 2900 referred to above. Sequentially opening the air closing means, for example, the valves of some compartments 3219, and closing the others enables dust removal through air nozzles 3100 of different compartments 3219.

The ventilator 3222 installed in the manifold 3200 allows the manifold 3200 to accumulate dust from the ambient space inside of the enclosure 100 while the air exhaust device 20 does not operate (is turned off). The functions of the ventilator 3222 may implement an exhaust fan if the device 10 contains it for forced cooling of electronic components inside of the enclosure 100. Filter 3300 holds dust inside of the manifold 3200 which is suspended in the airflow channeled through the ventilator 3222.

FIG. 5B demonstrates an example of a possible realization of a manifold 3200 with separated compartments. In the FIG. 5B the box 3210 of the manifold 3200 is demonstrated with the detached front panel 3211 and the disconnected air duct 2700. In accordance with the FIG. 5B, the volume of the box 3210 is divided on the two compartments 3219 by the partition plate 3220. Each of the compartments 3219 is connected with the air duct 2700 via the air coupler 3221. The shutter 3400 has two positions—‘left compartment open’ 3403 and ‘right compartment open’ 3404. In the position ‘left compartment open’ 3403 the shutter 3400 opens the air nozzles 3100 belonged to the left compartment of the box 3210 for free airflow through them and simultaneously closes the air nozzles 3100 belonged to the right compartment of the box 3210. In the position ‘right compartment open’ 3404 the shutter 3400 opens the air nozzles 3100 belonged to the right compartment of the box 3210 for free airflow through them and simultaneously closes the air nozzles 3100 belonged to the left compartment of the box 3210. According the FIG. 5B, the design of the manifold 3200 may also comprise the flap 2910 of the air closing means, for example, valve 2900, combined with the shutter 3400 into an integral structure, so the flap 2910 may be actuated by sliding the shutter 3400. In the position ‘left compartment open’ 3403 the flap 2910 opens the left air coupler 3221 for air flow through it and simultaneously closes the right air coupler 3221. In the position ‘right compartment open’ 3403 the flap 2910 opens the right air coupler 3221 for air flow through it and simultaneously closes the left air coupler 3221.

Instead of connecting different compartments 3219 to the single air duct 2700, each of the compartments 3219 may be connected to a separate air duct 2700. Herewith, several air ducts 2700, each of which is connected to a certain compartment 3219, are integrated by the air switcher 3000.

For various embodiments of the present invention, inside of a manifold 3200 may be located electronic components 200 and/or 300 and/or heat-dissipating modules 400 and/or any other components of the device 10 located inside of the enclosure 100. In this case the box 3210 of the manifold 3200 may have additional holes to enable electric connection (via wires, cables or harnesses) of electronic components located inside of the box 3210 with components 200 and/or 300 located outside of this box. To illustrate, a fan 420, which is a part of a heat dissipating module 400, may be located in the box 3210. In this case both sides of the box 3210 located parallel to inlet and outlet holes of the fan 420, respectively, may have plurality of air nozzles 3100 and two sliding shutters 3400. In ordinary operating mode of the heat dissipating module 400 the sliding shutters 3400 are set in the position ‘open’ to ensure unconstrained airflow through the fan 420. In the cleaning operating mode of the fan 420 the sliding shutters 3400 are set in the position ‘closed’ closing air nozzles 3100, and the air exhaust device 20 starts removing the dust, which is inside of the box 3210 including the dust precipitated on the case and the blades of the fan 420. While removing dust, the blades and/or the spindle of the fan 420 may be blocked to prevent the blades rotation. The blocking may be implemented, for example, by a mechanical clamp actuated by sliding the shutter 3400 or integrated with the shutter in a single unit. Another example is illustrated in the FIG. 5C. In the FIG. 5C is shown the manifold 3200 located inside of the enclosure 100 of a computer case. An electronic component 300 that is a computer power supply is located inside of the box 3210.

As said above, any component of the device 10 located inside of the enclosure 100 may be located inside of the manifold 3200. Thus, for effective cleaning of the piled dust from the inside and/or from the surface of the air closing and dust blowout preventing means, such as the filter 3300 or the valve 2900, said filter 3300 or the valve 2900, may be installed inside of the box 3210 that has the same design as the design of the box 3210 described above which is used for location of the fan 420 inside of it.

For various embodiments of the present invention, the box 3210 may be partially or completely integrated into the enclosure 100 or into any other element inside of the enclosure 100. Thus, at least a part of one or more following sides: a front side 1110, a back side 1120, a top side 1130, a bottom side 1140, left 1150 and right 1160 sides of the enclosure 100 may be simultaneously the front panel 3211, the back panel 3212, the top panel 3213, the bottom panel 3214, the left 3215 and right 3216 side panels of the box 3210, respectively. For example, the box 3210 of a manifold 3200 may be integrated into an enclosure 100 of a computer case, as it is shown in the FIG. 5C. The top panel of the box 3210 having the plurality of the air nozzles 3100 in a form of grid is at the same time the inner bottom of the enclosure 100 located at some distance from the bottom side 1140 parallel to it and having the same dimensions as the bottom side 1140. In this case the bottom parts of the front side 1110, the back side 1120, the left 1150 and right 1160 sides limited on the height by the distance between the bottom side 1140 and the inner bottom of the enclosure 100 are the front panel 3211, the back panel 3212, the top panel 3213, the bottom panel 3214, the left 3215 and right 3216 side panels of the box 3210, respectively.

For various embodiments of the present invention, if any side of the box 3210 that has the plurality of the air nozzles 3100 with form of grid or slot holes is located in a way that it has access from the outside of the box after taking out or opening one of a detachable, removable or opening panel 1600, then said grid or slot holes may serve as the guard of electronic components located inside of the box 3210 from mechanical impact. In this case said grid prevents from tangency of said electronic components by the hose fitting 40 if a person wants by himself (manually) to clean up from the dust the inner space of the enclosure 100 having removed the panel 1600 for this purpose, as it is shown in the FIG. 1D.

It will be apparent to those of ordinary skill in the art that any other alternative design of a manifold 3200 and/or a shutter 3400, providing the same functionality as the manifold and the shutter described above, may be used. For example, a manifold 3200 may have irregular (non-box) shape, and a shutter's 3400 design may include various types of shutter blades which close and open the air nozzles 3100 by changing the blades pitch, or the motion path of a shutter 3400 may be circular instead of linear, etc.

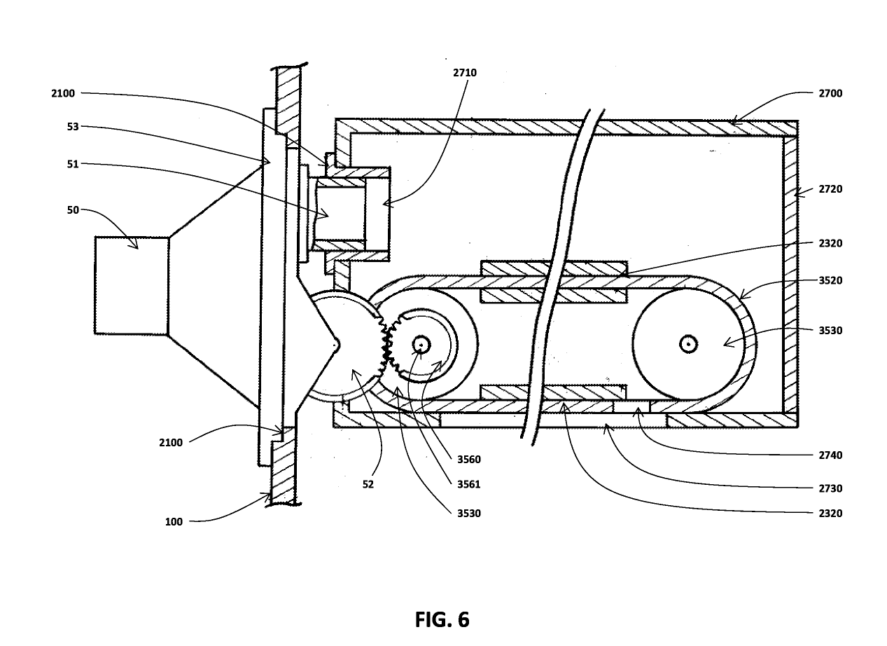

For various embodiments of the present invention, the end of an elongated airtight passageway, such as an air duct 2700, may have the ability to move inside of the enclosure 100 to ensure dust removal by only one air nozzle 3100 or by only one manifold 3200 put on the end of the elongated airtight passageway from various, distant from each other, places inside of the enclosure 100. In this case an air duct 2700 may have flexible structure (for example, it may be made of goffered plastic), and the enclosure 100 may additionally include a moving mechanism 3500 of the end of the air duct 2700. The moving mechanism 3500 may be mechanical, electrical, electromechanical or electronic. The moving mechanism 3500 may have the design enabling the movement of the end of the air duct 2700 along straight line (single-dimensional movement), on the plane (2D-movement), for example, by rotating the end of an air duct 2700 along the circumference, or in the space (3D-movement). Thus, the motion path of the end of an elongated airtight passageway may be a complex 3D-curve. In the FIGS. 1B-1C is illustrated an example of a moving mechanism 3500 having electromechanical design. As it is illustrated in the FIGS. 1B-1C, the moving mechanism 3500 includes the guide rail 3510 along which travels the end of the air duct 2700; the belt pulley (or toothed pulley) 3520, to which is mounted the end of the air duct 2700; the rollers 3530 with the belt pulley (or toothed pulley) 3540 on them, the rollers being mounted on the ends of the guide rail 3510; the forward-and-reverse motor 3550 serving for feeding the belt pulley (or toothed pulley) 3520; the toothed wheel 3560 mounted on the shaft 3551 of the motor 3550 serving for transmitting the rotation from the shaft 3551 to the belt pulley (or toothed pulley) 3540. An alternative design of the moving mechanism 3500 and of the air duct 2700 is depicted in the FIG. 6. As it is shown in the FIG. 6, the air duct 2700 has one end 2710 opened and the other end 2720 closed, and also has a window 2730 on a side of the air duct 2700, which leaves the part of the profile of the air duct 2700 open. Another opening 2740 is formed in the belt pulley (or toothed pulley) 3520 that is installed along the window 2730, complementing the air duct 2700 profile to closed one. The function of the guide rail 3510 perform (implement) the two guide slots 2320 enabling single-dimensional movement of the belt pulley (or toothed pulley) 3520 along them. The two rollers 3530 are mounted inside of the air duct 2700, and the toothed wheel 3560 is installed on the axle 3561 of one of the two rollers externally relative to the air duct 2700. The toothed wheel 3560 may be geared (engaged) with a driving means to transfer rotation to the toothed wheel 3560 and enabling linear motion of the belt pulley (or toothed pulley) 3520 and travelling of the opening 2740 formed in the belt pulley. It will be apparent to those of ordinary skill in the art that any other alternative designs of the moving mechanism 3500 may be used.

For various embodiments of the present invention, along with the injection air into the enclosure 100 may be conducted treatment of the interior of the enclosure 100 with various fluid, aerosol, and volatile substances for odor-control treatment and/or for pest control against organisms and germs that are inside of the enclosure 100. For that purpose inside of the enclosure 100 on the way of injection airflow may be installed a mixing module 3600 that contains said substances and allow admixing or injecting these matters into the airflow. A mixing module 3600 may be installed at any place of an air passageway on the way from the dust removal point (the air nozzle 3100 included as well for the initial point of the air passageway) and up to the air connector 2100 or to the hose fitting 40. For various embodiments of the present invention, at any place of an air passageway on the way from the air connector 2100 or the hose fitting 40 and up to the dust removal point (the air nozzle 3100 included as well for the initial point of the air passageway may be installed, besides the elements 2100-3600, the following additional elements facilitating better dust removal: an airflow divider 3800, an airflow swirler 3900, and an air pressure reducer 4000, as it is shown in the FIGS. 1B-1C.

The airflow divider 3800 cuts the airflow directed to or passing through the divider onto several streams, which allows cutting the inflated airflow onto several airstreams directed to the various parts inside of the enclosure 100 for efficient dust removal from the elements located in the various parts of the enclosure 100. To illustrate, the airflow divider 3800 may be a wedge installed in the air nozzle 3100 (in the exhaust hole of the air nozzle 3100), as it is shown in the FIG. 1C. In this case the airflow divider 3800 divides the airflow passing through the air nozzle 3100 onto two streams and deviates each of the streams on a certain angle relative to the center line of the air nozzle 3100. The wedge may have flexible articulation so it can be turned to various angles for changing the direction of the airstreams divided by the airflow divider 3800. The angle of the wedge may be changed automatically and periodically under influence of airflow directed to the wedge. In this case the wedge angle changing may be realized by means of a device similar to the air switcher 3000 referred to above, which automatically switches the connection between the ducts in a certain period of time. Alternatively, the airflow divider 3800 may be equipped with a mechanical, electrical, electro-mechanical, or electronic drive mechanism 3410 providing the wedge angle variation and operated and controlled automatically, or by a person (manually), or upon a command of a person (for example, by pressing certain key at the keyboard 530/630), or upon a command of the controller (processor) 7010.

The airflow swirler 3900, which is illustrated in the FIGS. 1B-1C, changes the shape (swirling) and/or the direction of the airflow targeted to or passing through the airflow swirler 3900, creating its turbulence and enabling blow-off from the different sides of elements located inside of the enclosure 100. The design of the airflow swirler 3900 may be the same as the design of the well-known vane swirler. The airflow swirler 3900 also may be implemented as the two or more air nozzles 3100 installed in a way that the airflow exhausted from one of the air nozzles intersects with the airflow exhausted from the other air nozzle, thus swirling each other. The airflow swirler 3900 may be operated and controlled the same way as the wedge of the airflow divider 3800 referred to above.

It will be apparent to those of ordinary skill in the art that any other alternative designs of the airflow divider 3800 and the airflow swirler 3900 may be used.

The air pressure reducer 4000 enables controlling the pressure of the air inflated by the air injection device 30 in order to prevent damage of some elements located inside of the enclosure 100 by too intensive flow of the blowing-off air. The air pressure reducer 4000 may be installed into the enclosure 100 in a way that the air bleed freely flows out of the enclosure 100 through the overpressure valve of the air reducer. For example, the overpressure valve of the air pressure reducer 4000 or the edge of the bleeder 4010 connected with the overpressure valve may be located on the outer surface of the enclosure 100, as it is shown in the FIG. 1C-1D. The air pressure reducer 4000 may be equipped with a mechanical, electrical, electro-mechanical, or electronic drive mechanism 3410 providing the opening pressure variation and operated and controlled automatically, or by a person (manually), or upon a command of a person (for example, by pressing certain key at the keyboard 530/630), or upon a command of the controller (processor) 7010, or operated by air passing through the air connector 2100, which enables changing the pressure of the inflated air that maybe useful when, for example, an air injection device 30 does not have air pressure control.

For various embodiments of the present invention, any of the devices 2100-2300, 2500, 2700-4000 made in form of an add-on module 2400 may have the attaching hardware 1061 that is movable relative each other for enabling their attaching to apertures 1200 and/or to decorative grids and meshes 1300 and/or to attaching hardware 1310 and/or to special mounts 1700 and/or 2600 located on the enclosure 100 around the apertures 1200 that are formed in enclosures of various devices being cleaned and which have various sizes and/or various locations relative to each other.

For various embodiments of the present invention, an enclosure 100 may have an aperture for passing through it and mounting inside of the enclosure 100 without it disassembling at least a part of the elements (devices) 2100-4000 or any combination thereof. To illustrate, the manifold 3200 can be installed into the enclosure 100 through the removable or opening (including pivoting) panels 1600, as it is shown in the FIG. 1D.

For various embodiments of the present invention, at least a part of any of the elements (devices) 2100-2200, 2700-3400, 3600-4000 may be connected without use of tools with at least a part of any of the elements (devices) 2100-2200, 2700-3400, 3600-4000 inserted into the enclosure 100 through one or more apertures formed in the enclosure 100. Additionally, at least a part of any of the elements (devices) 2700-3100, 3200, 3500 may be connected without use of tools with at least a part of any of the elements 2700-3100, 3200, 3500 inserted into the enclosure 100 through one or more apertures formed in the enclosure 100. To illustrate, as shown in the FIG. 6, an attachment 50 for the hose fitting 40 of the air exhaust 20 and/or the air injection 30 devices may comprise the following elements: a fitting 51 for connecting with an air connector 2100 disposed inside of the enclosure 100 of the device 10; a toothed wheel 52 rotated by the air sucked out by the air exhaust device 20 or inflated by the air injection device 30 the same way as are rotated so-called ‘turbo brushes’ for vacuum cleaners; and a connecting plate 53 for connecting to the aperture 1200 formed in the enclosure 100, which also is an air connector 2100 disposed on the surface of the enclosure 100 since it provides dust-leakless connection with the connecting plate 53. When inserting the attachment 50 into the device 10 through the aperture 1200 (or equally through the air connector 2100 formed in the enclosure 100), the fitting 51 and the connecting plate 53 contact with the air connectors 2100 disposed inside of an enclosure 100 and formed in the enclosure 100, respectively, and the toothed wheel 52 gears with the toothed wheel 3560, which is installed on the axle 3561 and which serves for transforming rotation of the toothed wheel 52 to linear motion of the belt pulley (or toothed pulley) 3520 of the moving mechanism 3500.

For various embodiments of the present invention, at least a part of the following elements (devices) may be connected with each other in any combination thereof to compose an air passageway on the way from the dust removal point and up to the air connector 2100 or to the hose fitting 40: air passage means, such as air connector 2100, adapter-reducers 2200, air ducts 2700, air hubs 2800, air switchers 3000, air nozzles 3100, and manifolds 3200; dust blowout preventing and air closing means, such as detachable plugs 2500, valves 2900, switchers 3000, filters 3300, and shutters 3400; mixing modules 3600; airflow dividers 3800; swirlers 3900; and pressure reducers 4000.

For various embodiments of the present invention, at least a part of the elements (devices) 2100-4000 or any combination thereof may either be integrated with the enclosure 100 or be separate one or more items externally attaching to the enclosure 100 with or without help of tooling. At least some of said elements (devices) may be combined with each other to form either internal or external arrangement. The arrangement may be designed in a way that the elements combined in the arrangement are movable and have the ability to move relative each other. Combining the elements (devices) into an arrangement may be done by their soft, flexible, or rigid connection. Each of said elements (devices) or any combination thereof, if they are attaching to the enclosure 100 without tooling, may be attached and removed from the enclosure 100 the same way like are attached and removed the add-on modules 2400 described above. To illustrate, a shutter 3400 completely or at least its part, if it is in the form of an add-on module, may be replaced by a flat panel 3700, preventing airflow through it, as it is shown in the FIG. 1D, having mounts 2321 for latching to the mating parts 1700 or 2600 of the enclosure 100. Alternatively, each of said above elements (devices) or any combination thereof, if they are attaching to the enclosure 100 without special tooling, may have no mounts for latching to the mating parts 1700 or 2600 of the enclosure 100, and/or the enclosure 100 may have no mating parts 1700 or 2600. In such cases each of said above elements (devices) or any combination thereof may have one or more attaching hardware items enabling their attachment to an enclosure of a cleaned device initially not intended for dust removal using the dust prevention techniques provided by the present invention. Such attaching hardware may have a design of straps belting at least a part of the enclosure or belting (through one or more of the apertures 1200) an element located inside of the enclosure; or of vacuum cups clipping to the surface of the enclosure or clipping (through one or more of the apertures 1200) to the surface of an element located inside of the enclosure; or of an adhesive tape or a layer of an adhesive substance coating at least a part of the body of the attaching item (device) adjoins with the surface of the enclosure or adjoins (through one or more of the apertures 1200) with the surface of an element located inside of the enclosure. To illustrate, air connectors 2100, valves 2900, filters 3300 and/or shutters 3400 made in the form of add-on modules may be interconnected, which could be done for easier and faster mounting of said elements on the enclosure 100, and interconnection of said elements may be rigid or flexible (for example, said elements may be interconnected with the use of straps) so that when they are put on the enclosure 100 they can be aligned with the respective apertures 1200 of the enclosure 100 by their moving along the elements connecting them (along the straps).

In an embodiment of the present invention, at least a part of the elements (devices) 2100-4000 or any combination thereof, instead of locating in or on the enclosure 100, may be inbuilt into an external relative to the enclosure 100 device.

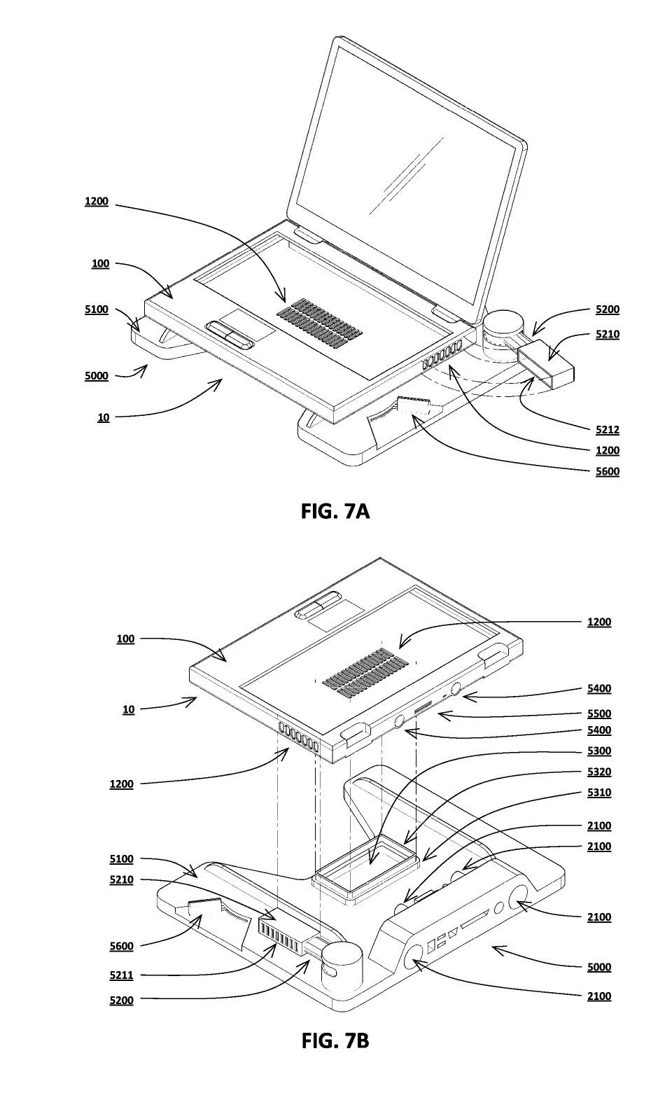

FIGS. 7A-7B illustrates an example of implementation of this embodiment. As it is shown in the FIGS. 7A-7B, air connectors 2100 and a shutter 3400 may be located on and/or inside of the body 5100 of the docking device 5000 of the laptop computer 10. The docking device 5000 may also comprise any elements 2100-4000, which are not shown in the FIGS. 7A-7B. The docking device 5000 is a docking device or a port replicator device manufactured by laptop computer producers. To apply the dust prevention techniques provided by the present invention, the docking device 5000 also contains air ports 5200 and 5300, located on the body 5100, through which is removed the dust from the laptop computer 10 and/or is inflated the air into the case 100 of the laptop computer 10. The air ports 5200 and 5300 are connected with the air connectors 2100 through air ducts 2700 located inside of the body 5100. Thus, the laptop computer 10 may only have elements which usually are needed for its functioning (for example, the elements 200-700), and also may have such standard for laptop computers elements of enclosure as the elements 1110-1700. Alternatively, the laptop computer 10 may additionally comprise air connectors 5400 mounted, for example, on the docking panel 5500 that is a part of the case 100. When docking the laptop computer 10, the apertures 1200 formed in the case 100 are aligned with the air ports 5200 and 5300, and the air connectors 5400 of the laptop computer 10 are coupled with the respective air connectors 2100 of the docking device 5000, and the air exhaust device 20 and/or air injection device 30 connected to the air connectors 2100 of the docking device 5000 may start the dust removal process. The air port 5200 and/or 5300 may have a movable (specifically, pivoted for the air port 5200 and telescopic for the air port 5300) design enabling the air port 5200 and/or 5300 movement (specifically, rotation for the air port 5200 and telescoping for the air port 5300) for movement towards the case 100 until contact with the enclosure 100 and for movement in opposite direction. The air port 5200 and/or 5300 may be equipped with a mechanical, electrical, electro-mechanical, or electronic moving mechanism 3500 providing the air port 5200 and/or 5300 movement operated and controlled automatically when the air exhaust 20 and/or the air injection 30 devices are connected to the air connectors 5400 or when the laptop computer 10 is docked, or by a person (manually), or upon a command of a person (for example, by pressing certain key at the keyboard 530/630), or upon a command of the controller (processor) 7010. As depictured in the FIGS. 5A-5B, when the laptop computer 10 is not docked, the air port 5200 takes the position shown in the FIG. 7A and the air port 5300 is folded; when the laptop computer 10 is docked, the air port 5200 may be moved (turned) into the position shown in the FIG. 7B by actuating the handle 5600 located on the body 5100 and the air port 5300 may be folded by actuating the handle 5600. The handle 5600 may not only activate the air port 5200 and/or 2300 but at the same time be the handle locking the laptop computer 10 when it is being docked. In this case to ensure continuous and unconstrained cooling through the apertures 1200 of the working laptop computer 10 locked to the docking device 5000, the air port 5200 may be equipped with the sliding shutter 3400. With the same purpose the air port 5300 may have telescopic design that includes a fixed part 5310 of the air port 5300 and one or more bends 5320 extending and folding, getting one into another and into the fixed part 5310. When the air port 5200 is equipped with the sliding shutter 3400, the housing 5210 of the sliding shutter 3400 also has the apertures in the form of slotted holes 5211 formed in the side of the housing 5210 opposite to the socket (bell mouth) 5212 of the sliding shutter 3400. When the laptop computer 10 is working and the air port 5200 is aligned with the apertures 1200 formed in the side face of the laptop computer 10, as it is shown in the FIG. 7B, then the sliding shutter 3400 is shifted into position ‘open’ by a moving mechanism, such as the moving mechanism 3500 referred to above, and the telescopic structure of the air port 5300 is folded so the airflow can freely and consecutively flow through the apertures 1200 and the slotted holes 5211 for cooling the elements inside of the case 100. In order to start dust removal process from the case 100, it is necessary to move the air port 5200 and/or unfold the telescopic structure of the air port 5300 so the both ports 5200 and 5300 contact with the surface patches of the case 100 at the places around the location of the apertures 1200, and/or it is necessary to slide the sliding shutter 3400 into the position ‘closed’ if the air port 5200 is equipped with the sliding shutter 3400. For this purpose, the sliding shutter 3400 may be equipped with a mechanical, electrical, electro-mechanical, or electronic moving mechanism 3500 providing the sliding shutter 3400 movement operated and controlled automatically when the air exhaust 20 and/or the air injection 30 devices are connected to the air connectors 5400, or by a person (manually), or upon a command of a person (for example, by pressing certain key at the keyboard 530/630), or upon a command of the controller (processor) 7010. If there are more than two apertures formed in the case 100, then at least one of them, instead of being connectable with the air port, may be connectable with the dust filter 3300, or with the plug 2500, or with the shutters 3400. The dust filter 3300 or the plug 2500 may be movably attached to the body 5100 of the docking device 5000 and may be operable the same way as the air ports 5200 and/or 5300.

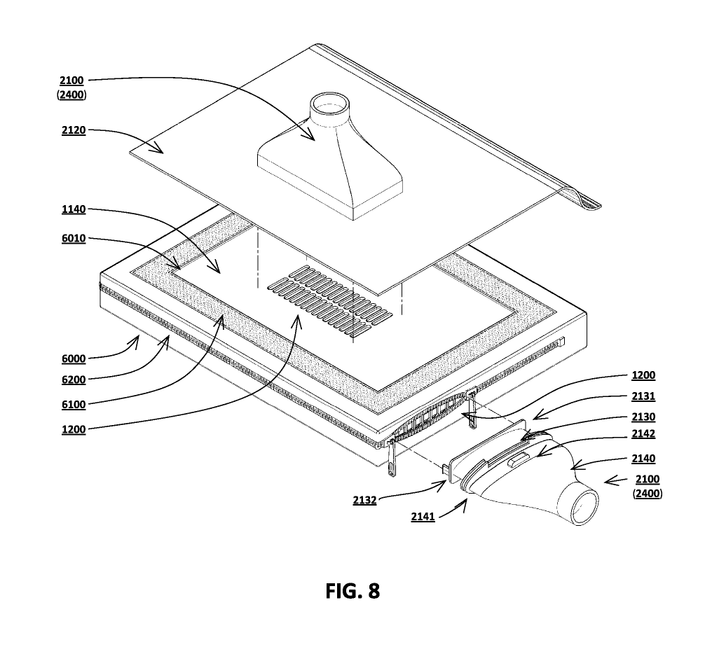

FIG. 8 illustrates another example of implementation of the present embodiment. As it is shown in the FIG. 8, an air connector 2100 may be a part of the receptacle, such as a cover 6000 put over the case 100 of a laptop computer 10. The cover 6000 may also comprise any elements 2100-4000, which are not shown in the FIG. 8. The receptacle may serve as an interconnecting element among various elements 2100-4000. In this case the receptacle is also an affixing element that is common for several interconnected elements 2100-4000 for their easier and more convenient attaching to the case 100. Thus, the receptacle should not necessarily prevent dust blowing out from the case 100; this function is implemented by one or more elements 2100-4000 connected with the case 100 by means of fitting the receptacle to the case 100. Alternatively, the receptacle may seal the device 10 against dust blowing out from the case 100 to the ambient space, so the case 100, at least partially, should be made of a dust impermeable material. The receptacle may not only serve for dust removing but also may be intended for transportation, carrying, or storing of the device 10. To illustrate, the receptacle may be a box or a carton for packing a laptop before it leaves a factory or a store, or a laptop sleeve or a laptop carrying case that has a laptop compartment having any elements 2100-4000 integrated in the box, sleeve or the laptop carrying case. The laptop computer 10 may only have elements which usually are needed for its functioning (for example, the elements 200-700), and also may have such standard for laptop computers elements of enclosure as the elements 1110-1700. At least a part of the receptacle may have rigid or soft or flexible structure and different parts of the receptacle may have different structures. To illustrate, the receptacle may generally have soft structure but at the same time may have some parts made of a plastic that have hardware for attaching of an add-on module 2400, such as an air connector 2100, to the receptacle. Moreover, the structure of different parts of the receptacle may be the same but their functionality may differ. To illustrate, the receptacle may generally be made of fabric that is impermeable to air, wherein some parts aligning with the apertures 1200 of the case 100 when the laptop computer 10 is put into the receptacle may be made of a fabric that allows air to freely pass through it but catches dust. In the FIG. 8 the cover 6000 has soft structure and can be folded. In this case the cover 6000 may be made of soft nonwoven materials or sewed of dust-proof fabric and may be easily cleaned off from the dust by laundering in a washing machine. The cover 6000 may not completely accommodate the laptop computer 10 but only put on a part of it. In this case along the perimeter of the open part (of the opening) of the cover 6000 may be lined with a strip of elastic material and tension-band strap for a snug fit of the perimeter of the open part of the cover 6000 to the case 100. An example illustrating such application is shown in the FIG. 12. The cover 6000 may tightly fit the laptop computer 10 or may have larger size for versatility, i.e. in order to be able to accommodate not only said laptop computer 10 but also various electronic devices as well. In case if the cover 6000 is of a larger size than the laptop computer 10, an additional volume of the enclosure 6000 may be made in the form of the expandable compartment partitioned from the main volume of the cover 6000 by, for example, the clips or by the zippers. The cover 6000 may also have the tightening cords to tighten the expandable volume and the whole cover 6000 up to the size of a device put into the cover. If the cover 6000 is universal (i.e. can accommodate various devices of different sizes), the air passage means, particularly air connectors 2100, may be movably attached to the cover 6000. For example, they may be installed on the sliding device 2300 sewed into the cover 6000 for their aligning with the respective air vents (apertures 1200) of laptop computers having different locations of the air vents.

In the FIG. 8, the cover 6000 comprises the detachable air connectors 2100 made in the form of add-on modules. The air connectors 2100 may be attached to and removed from the case 100 of the laptop computer 10 without help of tooling similar to attaching add-on modules 2400 described above. As it is illustrated in the FIG. 8, the air connectors 2100 may be attached to and removed from the case 100 also using hook-and-loop fastener 6100 and zippers 6200, which enables to use the cover 6000 of a common design for dust removing from different models of laptop computers 10 having different locations of the apertures 1200. Mountings of the air connectors 2100 to the cover 6000 with the use of zippers enables the use of ordinary laptop sleeves for dust removal equipped with zipper but initially not intended for cleaning the inside of the laptop computers.

In the FIG. 8, the air connector that is attached to the cover 6000 with the help of hook-and-loop fastener 6100 can be positioned exactly right over the apertures 1200 located on the bottom side 1140 of the laptop computer 10 due to the soft base 2120 of this air connector, which has hook-and-loop fastener strip along the perimeter of the soft base 2120, that is of a larger size than the window-cut 6010 in the cover 6000. Instead of it the soft base 2120 may be smaller by size (for example, narrower) than the window-cut 6010, wherein the not covered areas of the window-cut 6010 may be covered by soft air impermeable sheets, such as the soft flat panels 3700, attached to the cover 6000 also with the help of hook-and-loop fastener. The soft flat panels 3700 may be fastened by one or several parts of its perimeter to the cover 6000 or may be implemented as an integral unit with the cover 6000. To illustrate, the window-cut 6010 may be completely covered by the one or several soft flat panels 3700 that have the same width and are sewn-on to one side of the window-cut 6010. In this case the soft base 2120 is of the size which is multiple of the size of the flat panel 3700. To attach the air connector 2100 it is necessary to open the one or several soft flat panels 3700 located right above the apertures 1200, and replace them with the air connector 2100 using hook-and-loop fastener joining. The soft flat panels 3700 may have hook-and-loop fastener strips not only on one of its sides but also on the outside. In this case the size of the soft base 2120 may be bigger than the size of the soft flat panel 3700, and the soft base 2120 may be attached not directly to the cover 6000 but to the outside of the soft flat panels 3700.

The dimensions of the window-cut 6010, instead of being variable by means of the soft flat panels 3700, may be adjusted by means of a zipper or a cord attached along the perimeter of the window-cut. If an area of the cover 6000 along the perimeter of the window-cut 6010 is made of an elastic material and/or the cord is elastic, then the area of the window-cut 6010 can be adjusted by opening/closing the zipper or by loosening/tightening the strap.

The air connectors 2100, the add-on modules 2400, the valves 2900, the filters 3300 and the shutters 3400 may have dampers and/or have telescopic or extendible structure for tight abutment to the apertures 1200. An example of the design of the air connector 2100 with telescopic structure is illustrated in the FIG. 8. According to the FIG. 8, the air connector 2100 has the extendible part 2130 and the fixed part 2140 that attaches to the zipper 6100 of the cover 6000. The fixed part 2140 attaches to the zipper 6020 by the grooves 2141 which accommodate the zipper teeth. The fixed part 2140 has a lock-up mechanism for fixing the extendable part 2130 in a certain position by turning the handle 2142 of the lock-up mechanism. At the edge of the extendable part 2130 there is the area with the damper 2131 and two grip hooks 2132 for its engagement with the apertures 1200 of the electronic device 10. The grip hooks 2132 may have the design enabling them to move relative to each other to ensure engagement of the grip hooks 2132 with the apertures 1200 of various devices having various sizes of the apertures 1200.

The cover 6000 may have the design enabling effective dust removal from electronic devices with partially disassembled enclosure. To illustrate, the cover 6000 may be put on a TV set which back side has been detached. Along the perimeter of the open part (of the opening) of the cover 6000 may be lined with a strip of elastic material and tension-band strap to prevent from dust blowing out of the enclosure of the TV set beyond the cover 6000 without lifting and placing of the TV set into the cover 6000. The back side of the cover 6000, which replaces the detached back side of the TV set, may have the air connector 2100 being able to rotate. This enables directing the airstream into various parts of the TV set enclosure blowing into the enclosure of the TV set by the air injection device 30. The cover 6000 also includes another air connector 2100 for connecting the air exhaust device 20. For visual control and timely changing the airstream direction inflated by the air injection device 30, the back side or several sides of the cover 6000 may have transparent windows or they may be made of a transparent material (plastic).

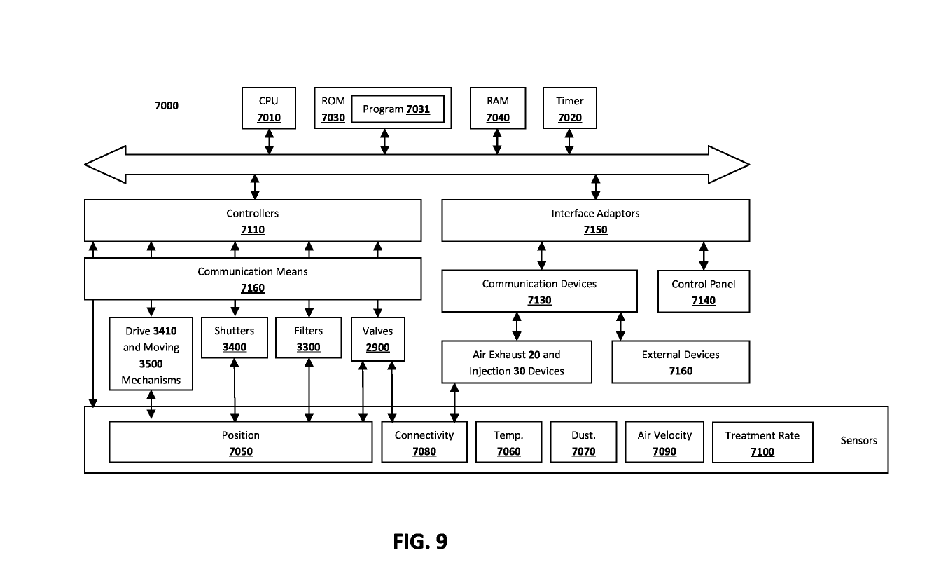

For various embodiments of the present invention, the device 10 may also include additional mechanical, electromechanical, electrical and electronic components logically and/or physically integrated into a single automation controlling module 7000, illustrated in the FIG. 1D, automating dust removal process. Alternatively, at least a part of the components that are included into the module 7000 or any combination thereof may not be included into the device 10 but can be external or be included into other external relative to the device 10 devices. As it is illustrated in the FIG. 9, the controlling module 7000 may include the central controller (processor) 7010 controlling operation of other components included into the said module 7000; the timer 7020 recording the duration of the operation and downtime of the device 10 and duration of the dust removal session; the nonvolatile memory (i.e., ROM) 7030 that stores the settings and ultimate values of timing, dust content, air temperature and airstream velocity, and also the algorithm (program) 7031 of operating and controlling the air exhaust 20 and injection 30 means, the air closing and dust blowout preventing means, such as the valves 2900, the filters 3300 and the shutters 3400, the drive mechanisms 3410 and the moving mechanisms 3500, the sliding devices 2300, the air passage means and their parts, such as the openings of the air ducts 2700, the switchers 3000, the air nozzles 3100, the manifolds 3200, the airflow dividers 3800, the swirlers 3900, the pressure reducers 4000, and service programs and other data; the random access memory (RAM) 7040 for temporary storing data and commands required by the central controller (processor) 7010 for implementation of operations composing the programs; the sensor 7050 of the positions (e.g., ‘open’ or ‘closed’) of the dust blowout preventing and air closing means, such as the valves 2900, the filters 3300, and the shutters 3400, and of the positions of the drive mechanisms 3410 and the moving mechanisms 3500, the sliding devices 2300, the air passage means and their parts, such as the openings of the air ducts 2700, the switchers 3000, the air nozzles 3100, the manifolds 3200, the wedges of the airflow dividers 3800, and the vanes of the swirlers 3900; the sensors: of the temperature 7060 of the elements inside of the enclosure 100 and/or of the air temperature in any point inside of the enclosure 100, of dustiness 7070 of any element inside of the enclosure 100 and/or in any point inside of the enclosure 100 and/or of the dust blowout preventing means, such as the filters 3300 in any point inside of the enclosure 100, of connectivity 7080 of the air exhaust device 20 and/or the air injection device 30 and connectivity or aligning the hose fitting 40 with the respective apertures 1200, of airstream velocity 7090 in any point inside of the enclosure 100, of treatment rate 7100 of any element inside of the enclosure 100 and/or in any point inside of the enclosure 100; the controllers 7110 for controlling the electrical, electromechanical and electronic the air closing and dust blowout preventing means, such as the valves 2900, the filters 3300 and the shutters 3400, the drive mechanisms 3410 and the moving mechanisms 3500, the sliding devices 2300, the air passage means and their parts, such as the openings of the air ducts 2700, the switchers 3000, the air nozzles 3100, the manifolds 3200, the wedges of the airflow dividers 3800, and the vanes of the swirlers 3900, and for data acquisition from the sensors 7060-7100; the control panel 7120 serving for warning about the start, end, and dust removal process flow, and also for entry of controlling commands and other information; the communication devices 7130 for link with the air exhaust 20 and the air injection 30 devices and with devices 7140 external relative to the device 10, such as computing devices, pocket digital assistants, communicators, cell phones, and so on; the interface adaptors 7150 interfacing the central controller (processor) 7010 and the components 7120-7130; commutation means (e.g., wires and cables) 7160 connecting the air closing and dust blowout preventing means, such as the valves 2900, the filters 3300 and the shutters 3400, the drive mechanisms 3410 and the moving mechanisms 3500, the sliding devices 2300, the air passage means and their parts, such as the openings of the air ducts 2700, the switchers 3000, the air nozzles 3100, the manifolds 3200, the airflow dividers 3800, the swirlers 3900, the pressure reducers 4000, and the sensors 7060-7100 with the controllers 7110; interface system or system bus (IS/SB) 7170 coupling the components 7010-7040 among each other and with the controllers 7110 and the interface adaptors 7150. The functions of the control panel 7120 may be implemented by the control panel 500. Functions of the communication devices 7130 may implement the communication module 700. In the FIGS. 1A-1D is shown only the module 7000, and communication means 7160 are not shown to avoid overloading the FIGS.

It is to be understood that any variants of considered possibilities of practical implementation including one with the use of the controlling module 7000 with the described above architecture may comprise elements omitted in the present description with the aim of clear and short description and may be changed or modified by those skilled in the art for more precise conformity between the automation controlling module 7000 realization and contemporary state of the art.

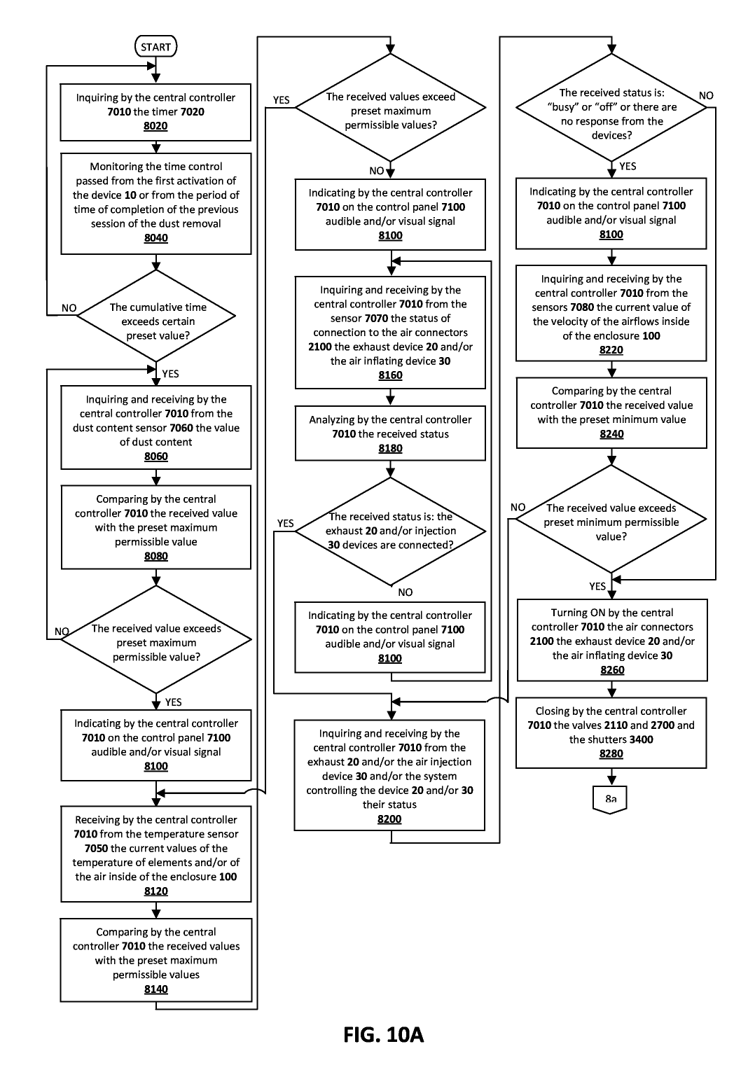

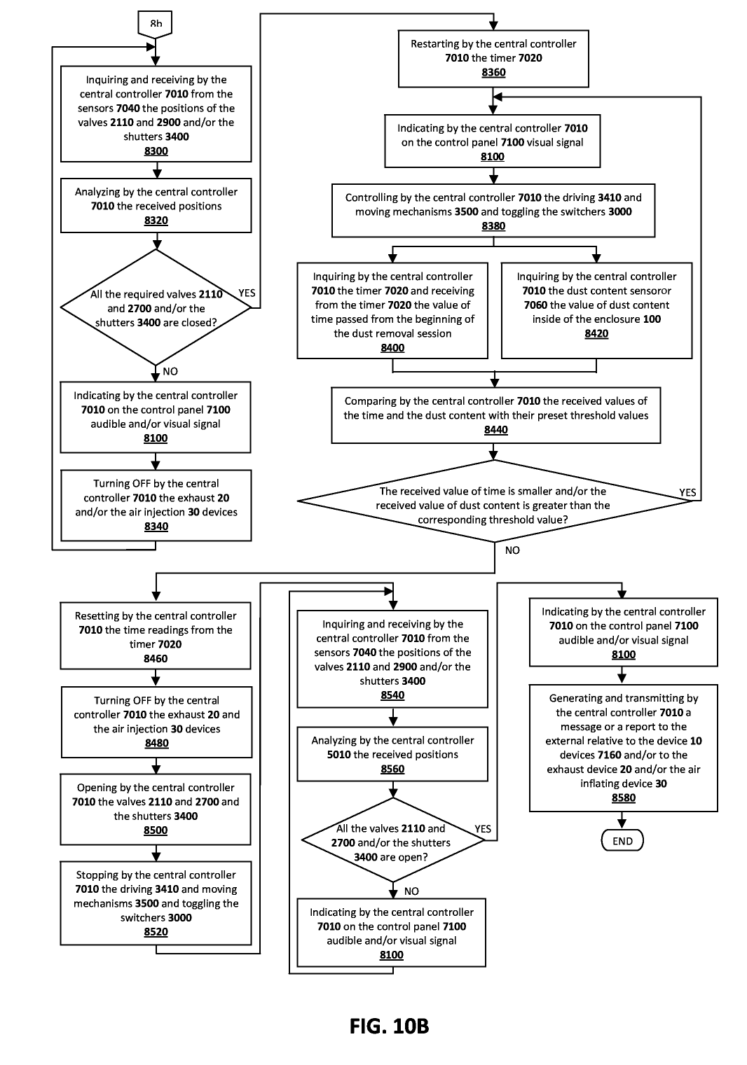

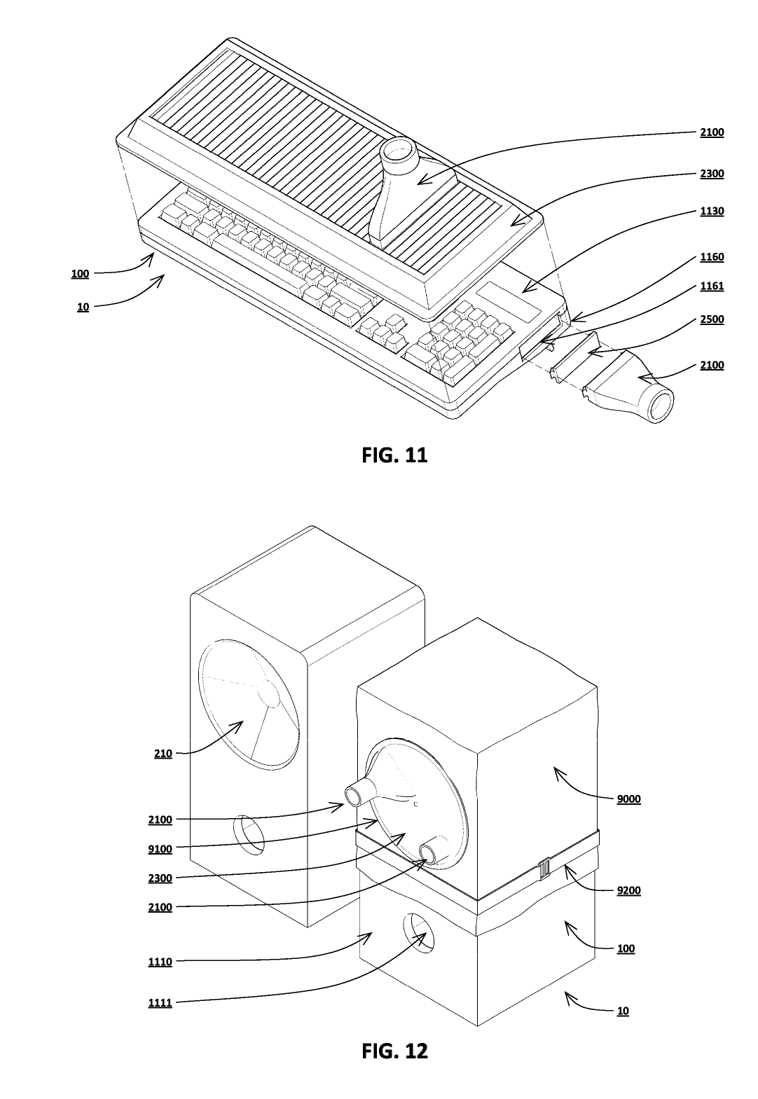

In the FIG. 10A-1013 is presented an algorithm 8000 of the controlling module 7000 and the central controller (processor) 7010 operation. According the algorithm 8000, the central controller 7010 inquiring 8020 the timer 7020 monitors 8040 the time control passed from the first activation of the device 10 or from the period of time of completion of the previous session of the dust removal. When the cumulative time exceeds certain value preset by a person (for example, entered by the person from the control panel 7120) or preset and stored in the nonvolatile memory 7030, the central controller 7010 inquires and receives 8060 from the dustiness sensor 7070 the value of dust content inside of the enclosure 100 and then compares 8080 it with the maximum permissible value preset by a person (for example, entered by the person from the control panel 7110) or preset and stored in the nonvolatile memory 7030. If the received from the dustiness sensor 7070 value of the dust content exceeds the maximum permissible value, the central controller 7010 indicates 8100 on the control panel 7120 audible and/or visual signal about the dust removal necessity and receives 8120 from the temperature sensor 7060 the current values of the temperature of elements and/or of the air inside of the enclosure 100 and compares 8140 with the maximum permissible values preset and stored in the nonvolatile memory 7030. As soon as the elements inside of the enclosure 100 cool down to the preset temperature, the central controller 7010 indicates 8100 on the control panel 7120 audible or visual signal on readiness to start dust removing, inquires and receives 8160 from the sensor 7080 the status of connectivity of the air exhaust device 20 and/or the air injection device 30 to the air connectors 2100 and analyses 8180 the received status. If the air exhaust device 20 and/or the air injection device 30 are not connected to air connectors 2100, the central controller 7010 indicates 8100 on the control panel 7120 audible or visual signal about the necessity to switch on the air exhaust device 20 and/or the air injection device 30 and continues receiving 8120 of the status from the sensor 7080. As soon as the central controller 7010 receives from the sensor 7080 the status “connected”, it is trying 8200 via communication devices 7130 to connect with the air exhaust device 20 and/or with the air injection device 30 and/or with the system controlling the air exhaust device 20 and/or the air injection device 30, such as the system of the central dust removal, to receive from the device or from the system its status. In case if neither from the air exhaust device 20 nor from the air injection device 30 there is no response or from the air exhaust device 20 and/or the injection device 30 comes a response “off” or “busy”, the central controller 7010 indicated 8100 on the control panel 7120 audible or visual signal on necessity to switch the power on to the air exhaust and/or the air injection devices and turn them in the “ready” mode or manually turn them on to start the dust removal session, and also continues receiving 8200 of the status from the air exhaust device 20 and/or the injection device 30. Along with the action 8200 the central controller 7010 inquires and receives 8220 from the sensors 7090 the current value of the velocity of the airflows inside of the enclosure 100 and compares 8240 it with the minimum value preset and stored in the nonvolatile memory 7030. Said minimum value characterizes the airflow velocity inside of the enclosure 100 at the beginning of the operation with minimum power of the air exhaust device 20 and/or air injection device 30. As soon as from the air exhaust device 20 and/or from the air injection device 30 comes the response “ready” and/or the air stream velocity inside of the enclosure 100 exceeds the said minimum value, the central controller 7010 turns on 8260 via the communication devices 7130 the air exhaust device 20 and/or the air injection device 30 and closes 8280 at least some of the dust blowout preventing and the air closing means, such as the filters 3300, the valves 2900 and the shutters 3400, for preventing dust blowing out from the enclosure 100 to the ambient space if the air injection device 30 is operating. Afterwards, the central controller 7010 inquires and receives 8300 from the sensors 7050 the positions of the said closed dust blowout preventing and the air closing means and analyses 8320 the received information. If at least one of the said closed dust blowout preventing and the air closing means remains faulty open, then the central controller 7010 indicates 8100 on the control panel 7120 audible or visual signal on error and the necessity to manually close the them and turns off 8340 via the communication devices 7120 the air exhaust device 20 and/or the air injection device 30. As soon as all of the faulty open air closing means are closed correctly, the central controller 7010 restarts 8360 the timer 7020 and in the course of all session of dust removal indicates 8100 on the control panel 7120 its actual values, which is the length of the time of the dust removal. While the dust removal, the central controller 7010 via the controllers 7110 performs 8380 the following operations simultaneously or consequently: changing travel direction of the moving mechanisms 3500 and changing the position of the dust blowout preventing and closing means connected with the drive mechanisms 3410 for opening some and closing other dust blowout preventing and air closing means, such as the valves 2900, the filters 3300 and the shutters 3400 and/or alternate opening and closing the same dust blowout preventing and air closing means; for moving the air passage means or their openings, such as the openings of the air ducts 2700, the air nozzles 3100, and the manifolds 3200; for switching between various air passage means, such as the air connectors 2100, the air ducts 2700, the air nozzles 3100, the manifolds 3200 compartments; for cutting an airflow onto several streams; for changing the shape (swirling) and/or the direction of the airflows. The said operations may be implemented in accordance with preset algorithms (programs) stored in the nonvolatile memory 7030. While the dust removal the central controller 7010 also enquires and receives 8400 from the timer 7020 the value of time passed from the beginning of the dust removal session and/or enquires and receives 8420 from the dustiness sensor 7070 the value of dust content inside of the enclosure 100. Having received said data, the central controller 7010 compares 8440 it with their threshold values preset by a person (for example, entered by a person from the control panel 7110) or preset and stored in the nonvolatile memory 7030. The time threshold value characterizes the period of time that is sufficient for dust removal from the enclosure 100. The threshold value of the dust content characterizes the level of the dust content when the interior of the enclosure 100 is considered to be free from the dust. As soon as the received time value, indicating the time passed from the beginning of the dust removal session, and/or the value of the dust content will appear to be respectively greater and lower of the respective threshold values, the central controller 7010 resets 8460 the time reading from the timer 7020 from the beginning of the dust removal session, turns off 8480 via the communication devices 7130 the air exhaust device 20 and the air injection device 30, opens 8500 the dust blowout preventing and air closing means, such as the filters 3300, the valves 2900, and the shutters 3030, and stops 8520 the moving mechanisms 3500 and stops toggling the air switchers 3000. Afterwards, the central controller 7010 enquires and receives 8540 from the sensors 7050 the position of the dust blowout preventing and air closing means, such as the filters 3300, the valves 2900 and shutters 3030, and analyses 8560 the received information. If at least one of the dust blowout preventing and air closing means remain closed, then the central controller 7010 indicates 8100 on the control panel 7120 audible or visual signal on error and on the necessity to manually open the dust blowout preventing and air closing means. As soon as all of the dust blowout preventing and air closing means are open, the central controller 7010 indicates 8100 on the control panel 7120 audible or visual signal on successfully completed session of the dust removal and generates and transmits 8580 via the communication devices 7130 a message or a report to the external relative to the device 10 devices 7140, such as a personal computer or a cell phone, and/or to the air exhaust device 20 and/or the air injection device 30.

### EXAMPLES

### Computer Keyboard

A computer keyboard is usually subject to heavy dust concentration if it is located on a desk without the keyboard dust protective cover, and the same even if the keyboard is located in the under table keyboard drawler. The dust accumulated in the keyboard may be the cause of its performance degradation, particularly if the keypad is of scissor-switch type. The keys of the keypad have bevel faces and are located on a certain distance from each other, therefore, when working with the keypad, there easily may get foreign particles and small objects such as paper clips, pins, etc. Foreign objects and particles often make impossible to press one or several keys of the keypad and may destroy the mechanism of the keypad, particularly the pad of a scissor-switch type. The use of a vacuum cleaner for removing foreign particles and objects from a standard currently produced keypad is ineffective since the keys are located close to each other and ingressed into the keypad particles or foreign objects if they changed their position are hard to remove through the gaps between the keys. The present invention enables solution of dust and foreign objects removal from keyboards. FIG. 11 illustrates an embodiment of the present invention for dust removal from a computer keyboard. In accordance with the FIG. 11, the computer keyboard 10 includes the case 100 containing a front side 1110; a back side 1120; a top side 1130 having plurality of the keys; a bottom side 1140; left 1150 and right 1160 sides; the aperture 1161 located on the right side 1160; the air connector 2100 located on the right 1160 side, the connector having detachable or removable design enabling its mounting over the aperture 1161; the plug 2500 implemented as an add-on module 2400 that is inserted instead of the removed air connector 2100. The computer keyboard 10 also includes the add-on sliding device 2300 having the air connector 2100 installed on the sliding device, which design was described above. The sliding device 2300 is put over the top side 1130.

Before the dust removal session start, the air connector 2100 is attached to the right side 1160. Then, to the air connector 2100 is connected the air exhaust device 20. Thus, the interior of the keyboard 10 becomes accessible for dust removal by the air exhaust device 20. After turning on the air exhaust device 20, the air connector 2100, located on the sliding device 2300, is sled by a person along the longer side of the keyboard 10 to create inside of the case 10 a directed airstream sucked into the case 10 through the gaps between the keys located the furthest away from and then closer to the air connector 2100 located on the right side 1160. For more efficient dust removal, to the air connector 2100, located on the sliding device 2300, may be mounted the air injection device 30. After completion of the dust removal session, the air connector 2100, located on the right side 1160, may be removed, the keypad may be turned vertically with the side 1160 down and the foreign objects that were not sucked out by the air exhaust device 20 may be simply shacked out from the case 100 through the aperture 1161.

### Audio Speakers

Audio speakers are subject to heavy dust concentration particularly floor standing ones. The dust penetrates as directly through the frontal protective grill mesh (often not detachable or removable), as well as through the backside apertures in the cabinet of the columns required for quality sounding of the audio speakers. To remove the dust accumulated inside of the audio speaker cabinet is often difficult since it may require its relocation and its complete disassembly. The present invention enables to solve the problem of dust removal from the cabinets of audio speakers. FIG. 12 illustrates an embodiment of the present invention for dust removal from the cabinet of an audio speaker. In accordance with the FIG. 12, the audio speaker 10 has the cabinet 100 that includes a front side 1110; a back side 1120; a top side 1130; a bottom side 1140; left 1150 and right 1160 sides. The front side 1110 of the cabinet 100 has the aperture 1111 for outcome of acoustic waves from the cabinet 100 for better sounding of the audio speaker 10. The cabinet 100 has the soft cover 9000 protecting the audio speaker 10 from dust when the audio speaker does not work. To enable dust removal, into the soft cover 9000 has sewed the ring 9100 with the diameter equal to or slightly bigger than the diameter of the loudspeaker 210 of the audio speaker 10. The ring 9100 has a groove around whole circumference of the ring, into which inserted the sliding device 2300 of circular shape. Thereby, the sliding device 2300 has common with the loudspeaker 210 center and may rotate relative to this center in plane parallel to the front side 1110. The sliding device 2300 includes two air connectors 2100 that may slide towards and from each other along the diameter of the loudspeaker 210. Thus, each of the two air connectors 2100 may be positioned against of any part of the loudspeaker's 210 cone. The soft cover 9000 has also tension-band straps 9200 for a snug fit of the sliding device 2300 to the perimeter of the loudspeaker 210.

Before starting the dust removal session, to one of the two air connectors 2100 should be connected the air injection device 30, and to another one—the air exhaust device 20 or the depth filter—dust collector 3300. Rotating the sliding device 2300 and moving along the diameter of the sliding device one or two of the air connectors 2100, enables dust removing from any part of the loudspeaker's 210 cone.

To remove the dust from inside of the cabinet 100, it is necessary to put into the aperture 1121 the air connector 2100 implemented in the form of interchangeable nozzle for the hose of the air exhaust device.

According to various embodiments of the present invention, the audio speaker 10 may also have any of the elements 2100-4000. In this case at the inner side of the aperture 1121 may be installed the air switcher 2800, to which are connected one or more air ducts 2700 serving for dust removal from the various places of the inside of the cabinet 100. This may be done, for example, if the audio speaker 10 has several inner compartments for better sounding. The air switcher 3000 may have at least two positions: ‘sound’ and ‘cleaning’. When the air switcher 3000 is in the position ‘sound’, the air switcher connects the aperture 1121 directly with the whole inner volume of the cabinet 100 for unconstrained exit of the sound waves from the cabinet 100. When the air switcher 3000 is in the position ‘cleaning’, the air switcher connects the aperture 1121 with said one or more air ducts 2700 for effective dust cleaning from the various parts of the inside of the cabinet 100.

1) Apparatus for removing dust from an enclosure of an electronic device and prohibiting that dust from entering the ambient air, the apparatus comprising:
the electronic enclosure having a plurality of apertures, at least one selected pair of which define an air passageway therebetween, the plurality of apertures comprising at least one aperture other than the at least one selected pair, the at least one other aperture useable for cooling the electronic device disposed inside the enclosure;
at least one sealing member in sealing engagement with the at least one other aperture;
at least one external air moving apparatus attachable to the enclosure and operable to move air from a first of the selected pair of apertures to the second; and
at least one dust trap connected to the second aperture of the at least one selected pair of apertures.

2) The apparatus of claim 1 wherein the at least one air moving apparatus comprises a pressurized air source operable to increase air pressure in the enclosure above ambient atmospheric pressure.

3) The apparatus of claim 1 wherein the at least one air moving apparatus comprises a vacuum generating apparatus operable to decrease air pressure in the enclosure below ambient atmospheric pressure.

4) The apparatus of claim 1 wherein the at least one air moving apparatus comprises both a pressurized air source connected to the at least one first aperture and a vacuum generating apparatus attached to the at least one second aperture.

5) The apparatus of claim 1 wherein the at least one sealing member is internal to the enclosure.

6) The apparatus of claim 1 wherein the at least one sealing member is external to the enclosure.

7) The apparatus of claim 1 wherein the at least one sealing member is impermeable to air.

8) The apparatus of claim 1 wherein the at least one sealing member is permeable to air but impermeable to dust.

9) The apparatus of claim 1 wherein the at least one sealing member comprises a plug.

10) The apparatus of claim 1 wherein the at least one sealing member comprises a receptacle fitted to the enclosure in sealing engagement therewith.

11) The apparatus of claim 1 wherein the at least one sealing member comprises a shutter attached to the enclosure.

12) The apparatus of claim 1 wherein the at least one sealing member is movable into sealing engagement responsive to attachment of the at least one external air moving apparatus to the enclosure.

13) The apparatus of claim 1 wherein the at least one external air moving apparatus is attached to the enclosure through a sliding device operable to selectively align an air stream generated by the at least one external air moving apparatus with a selected portion of a selected one of the selected pair of apertures.

14) The apparatus of claim 1 wherein the at least one dust trap is internal to the enclosure.

15) The apparatus of claim 1 wherein the at least one dust trap is external to the enclosure.

16) The apparatus of claim 1 further comprising an elongated air-tight passageway operable to convey air between two openings, wherein one of the openings is attached to a mechanism operable to selectively move the one of the openings about within the enclosure.

17) The apparatus of claim 1 further comprising an air switcher having an input from at least one of the selected pair of apertures and operable to provide an alternating output to at least two air passageways.

18) The apparatus of claim 1 wherein at least one of the selected pair of apertures is connectable to an air port in a docking station operable to provide electric power to a circuit in the enclosure, wherein the docking station is interposed between the enclosure and the external air moving apparatus.

19) A method of removing dust from an enclosure for an electronic device and prohibiting that dust from entering the ambient air, the method comprising the steps of:
a) providing the enclosure having at least three apertures, at least one of which is usable for cooling the electronic device,
b) selecting, from the plurality of apertures at least one air inlet and at least one air outlet;
c) sealing each aperture that is not selected as an air inlet or an air outlet;
d) generating at least one air stream extending between ones of the at least one air inlet and at least one air outlet so as to move dust-laden air toward each of the at least one outlets; and
e) removing, by means of at least one dust trap, the dust from the dust laden air.

20) The method of claim 19 wherein the step of sealing comprises operating at least one shutter attached to the enclosure.

21) The method of claim 19 wherein the step of sealing comprises attaching at least one impermeable sheet to the enclosure.

22) The method of claim 19 wherein the step of sealing comprises fitting at least one receptacle to the enclosure.

23) The method of claim 19 wherein the step of sealing comprises docking the enclosure in a docking station operable to provide electric power to circuitry in the enclosure, the docking station having at least one sealing member aligned with an aperture that is not selected as an air inlet or an air outlet.

24) The method of claim 19 the step of generating an air stream comprises blowing pressurized air into at least one air inlet.

25) The method of claim 19 wherein the step of generating an air stream comprises exhausting air through at least one air outlet.

26) The method of claim 19 wherein the step of generating an air stream comprises both blowing pressurized air into at least one air inlet and exhausting air from at least one air outlet.

27) Apparatus for removing dust from an enclosure of an electronic device and prohibiting that dust from entering the ambient air, the apparatus comprising:
the electronic enclosure comprising at least two apertures defining at least one air passageway therebetween;
a receptacle fitted to the enclosure and providing at least two openings aligned with the at least two apertures, at least one opening cooperating with at least one external air connector;
at least one air moving apparatus external to the enclosure, the air moving apparatus attachable to the at least one air connector and operable to cause air to move through the at least two openings in the receptacle and thus through the at least one air passageway; and
at least one dust trap external to the enclosure and positioned so as to receive the air moved through the at least one air passageway when the air moving apparatus is operating.

28) The apparatus of claim 27 wherein the receptacle comprises a material permeable to air but impermeable to dust.

29) The apparatus of claim 27 wherein the receptacle comprises a material impermeable to air.

30) Apparatus for removing dust from an enclosure of an electronic device and prohibiting that dust from entering the ambient air, the apparatus comprising:
the electronic enclosure comprising at least two apertures defining at least one air passageway therebetween;
a receptacle comprising a portion permeable to air but impermeable to dust, the receptacle fitted to the enclosure and providing at least one opening aligned with one of the at least two apertures, the at least one opening cooperating with at least one external air connector;
at least one air moving apparatus external to the enclosure, the air moving apparatus attachable to the at least one air connector and operable to cause air to move through the at least one opening in the receptacle, through the at least one air passageway and through the portion of the receptacle permeable to air but not permeable to dust whereby dust removed from the enclosure is captured within the receptacle.

31) Apparatus for removing dust from an enclosure of an electronic device and prohibiting that dust from entering the ambient air, the electronic device operable to receive electric power from a docking station, the apparatus comprising:
the enclosure comprising a plurality of apertures, at least two of the apertures defining at least one enclosure air passageway therebetween, the enclosure air passageway-disposed within the enclosure;
the docking station having a first air port aligned with and connectable to a first of the two apertures defining the at least one enclosure air passageway when the electronic device is docked, the first air port defining one end of a first docking station air passageway extending through the docking station;
an air moving apparatus external to the enclosure and operable to cause air to move through the enclosure and the first docking station air passageways when the docking station is connected to the enclosure; and
a dust trap external of the enclosure and positioned so as to receive the air moved through the enclosure and the first docking station air passageway when the air moving apparatus is operating.

32) The apparatus of claim 31 wherein the docking station further comprises a second air port aligned with and connectable to the second of the at least two apertures defining the at least one enclosure air passageway when the electronic device is docked, the second air port defining one end of a second docking station air passageway extending through the docking station, wherein the air moving apparatus is operable to cause air to move along a path extending through the first docking station air passageway, the enclosure air passageway and the second docking station air passageway.

33) The apparatus of claim 31 wherein the dust trap is disposed within the docking station.

34) The apparatus of claim 31 wherein the air port comprises a movable member operable to connect the air port to the enclosure.
